(19) United States
(12) Patent Application Publication
(10) Pub. No.: US 2024/0351342 A1
(43) Pub. Date: Oct. 24, 2024

(54) LIQUID EJECTION HEAD AND LIQUID EJECTION APPARATUS

(71) Applicant: CANON KABUSHIKI KAISHA, Tokyo (JP)

(72) Inventors: KAZUYA YOSHII, Kanagawa (JP); YUSHI KITASE, Tokyo (JP); NAOZUMI NABESHIMA, Tokyo (JP)

(21) Appl. No.: 18/638,290

(22) Filed: Apr. 17, 2024

(30) Foreign Application Priority Data
Apr. 18, 2023 (JP) 2023-067761

(51) Int. Cl. B41J 2/175; B41J 2/14

(52) U.S. Cl. CPC B41J 2/17596; B41J 2/14; B41J 2002/14193; B41J 2202/05; B41J 2202/07; B41J 2202/12

(57) ABSTRACT

A liquid ejection head and a liquid ejection apparatus that can suppress the occurrence of ejection failure are provided. A pressing plate moves as the volume of a first pressure adjusting chamber decreases, thereby increasing a flow resistance of a passage connected to a supply passage through a second discharge passage relative to a flow resistance of a passage connected to the supply passage through a first discharge passage.

### BACKGROUND OF THE INVENTION

### Field of the Invention

The present disclosure relates to a liquid ejection head and a liquid ejection apparatus including the liquid ejection head.

### Description of the Related Art

A circulating type liquid ejection apparatus is known that circulates a liquid between a liquid ejection head and a liquid storage unit to discharge air bubbles in a passage and suppress the thickening of ink near ejection ports. Some circulating type liquid ejection apparatuses use a main body side pump outside a liquid ejection head to circulate a liquid between the liquid ejection head and the main body, while others use a pump inside the liquid ejection head to circulate the liquid inside the liquid ejection head.

Japanese Patent Laid-Open No. 2014-195932 discloses a liquid ejection apparatus that circulates ink inside a liquid ejection head by mounting a piezoelectric circulation pump in the liquid ejection head. In the configuration disclosed in Japanese Patent Laid-Open No. 2014-195932, ink supplied from the circulation pump to a pressure control mechanism is supplied to a pressure chamber through an ink supply passage, and ink that was not ejected is supplied to the circulation pump through an ink collection passage.

A circulating type liquid ejection head as disclosed in Japanese Patent Laid-Open No. 2014-195932 has more ink passages such as the ink collection passage than a non-circulating type liquid ejection head, which tends to increase ink storage capacity in the liquid ejection head. In Japanese Patent Laid-Open No. 2014-195932, an ink supply tube that supplies ink to the pressure chamber from an ink filling chamber located upstream of the pressure chamber is disposed at the bottom of the ink filling chamber. If air bubbles are generated in the ink filling chamber, the bubbles are accumulated by buoyancy in the upper part of the ink filling chamber. In a configuration in which the ink supply tube for discharging such bubbles from the ink filling chamber is disposed at the bottom of the ink filling chamber as in Japanese Patent Laid-Open No. 2014-195932, it may become difficult to discharge the bubbles generated in the ink filling chamber.

Particularly, as the ink storage capacity inside the liquid ejection head increases, the amount of remaining air bubbles in the liquid ejection head tends to increase. In a configuration in which the amount of remaining air bubbles tends to increase and it is difficult to discharge the air bubbles, the remaining air bubbles may eventually flow into the pressure chamber, causing ejection failure.

### SUMMARY OF THE INVENTION

Therefore, the present disclosure provides a liquid ejection head and a liquid ejection apparatus that can suppress the occurrence of ejection failure.

A liquid ejection head according to the present disclosure includes: an ejection port for ejecting a liquid; an ejection element for generating a pressure to eject the liquid from the ejection port; a pressure chamber provided with the ejection element and communicated with the ejection port; and a first pressure adjusting unit capable of changing a volume according to the pressure of the liquid and adjusting the pressure of the liquid. The liquid ejection head further includes: a first passage connecting the first pressure adjusting unit and the pressure chamber; a first outlet provided in a vertically upper part of the first pressure adjusting unit; a first discharge passage connecting the first outlet and the first passage; a second outlet provided in the first pressure adjusting unit; and a second discharge passage connecting the second outlet and the first passage. In a case where the volume of the first pressure adjusting unit decreases, the liquid ejection head includes a flow resistance increasing unit for increasing a flow resistance in a passage through which the liquid flows from the first pressure adjusting unit to the first passage through the second outlet and the second discharge passage, with respect to a flow resistance in a passage through which the liquid flows from the first pressure adjusting unit to the first passage through the first outlet and the first discharge passage.

According to the present disclosure, a liquid ejection head and a liquid ejection apparatus that can suppress the occurrence of ejection failure can be provided.

Further features of the present invention will become apparent from the following description of exemplary embodiments with reference to the attached drawings.

### BRIEF DESCRIPTION OF THE DRAWINGS

FIG. 1A is a diagram illustrating a liquid ejection apparatus;

FIG. 1B is a diagram illustrating the liquid ejection apparatus;

FIG. 2 is an exploded perspective view of a liquid ejection head;

FIG. 3A is a vertical sectional view of the liquid ejection head;

FIG. 3B is an enlarged cross-sectional view of an ejection module;

FIG. 4 is a schematic external view of a circulation unit;

FIG. 5 is a vertical sectional view showing a circulation path;

FIG. 6 is a block diagram schematically showing the circulation path;

FIG. 7A is a cross-sectional view showing an example of a pressure adjusting unit;

FIG. 7B is a cross-sectional view showing an example of the pressure adjusting unit;

FIG. 7C is a cross-sectional view showing an example of the pressure adjusting unit;

FIG. 8A is an external perspective view of a circulation pump;

FIG. 8B is an external perspective view of a circulation pump;

FIG. 9 is a cross-sectional view taken along line IX-IX of the circulation pump shown in FIG. 8A;

FIG. 10A is a diagram illustrating an ink flow inside the liquid ejection head;

FIG. 10B is a diagram illustrating the ink flow inside the liquid ejection head;

FIG. 10C is a diagram illustrating the ink flow inside the liquid ejection head;

FIG. 10D is a diagram illustrating the ink flow inside the liquid ejection head;

FIG. 10E is a diagram illustrating the ink flow inside the liquid ejection head;

FIG. 11A is a schematic diagram showing a circulation path in an ejection unit;

FIG. 11B is a schematic diagram showing the circulation path in the ejection unit;

FIG. 12 is a diagram showing an aperture plate;

FIG. 13 is a diagram showing an ejection element substrate;

FIG. 14A is a cross-sectional view showing an ink flow in the ejection unit;

FIG. 14B is a cross-sectional view showing the ink flow in the ejection unit;

FIG. 14C is a cross-sectional view showing the ink flow in the ejection unit;

FIG. 15A is a cross-sectional view showing the vicinity of an ejection port;

FIG. 15B is a cross-sectional view showing the vicinity of the ejection port;

FIG. 16A is a cross-sectional view showing the vicinity of the ejection port in a comparative example;

FIG. 16B is a cross-sectional view showing the vicinity of the ejection port in the comparative example;

FIG. 17 is a diagram showing a comparative example of the ejection element substrate;

FIG. 18A is a diagram showing a passage configuration of a liquid ejection head;

FIG. 18B is a diagram showing the passage configuration of the liquid ejection head;

FIG. 19 is a diagram showing a connection state of a main body of the liquid ejection apparatus and the liquid ejection head;

FIG. 20A is a diagram schematically showing an ink backflow around the ejection port;

FIG. 20B is a diagram schematically showing the ink backflow around the ejection port;

FIG. 21A is a diagram illustrating ink supply inside the ejection module;

FIG. 21B is a diagram illustrating ink supply inside the ejection module;

FIG. 22A is a diagram schematically showing a passage configuration in a liquid ejection head;

FIG. 22B is a diagram schematically showing the passage configuration in the liquid ejection head;

FIG. 23A is a front sectional view of a first pressure adjusting chamber;

FIG. 23B is a front sectional view of the first pressure adjusting chamber;

FIG. 24 is a diagram schematically showing a passage configuration in a liquid ejection head;

FIG. 25 is a graph showing the relationship between a flow resistance and a distance;

FIG. 26A is a diagram schematically showing a passage configuration in a liquid ejection head;

FIG. 26B is a diagram schematically showing a passage configuration in a liquid ejection head;

FIG. 26C is a diagram schematically showing a passage configuration in a liquid ejection head;

FIG. 26D is a diagram schematically showing a passage configuration in a liquid ejection head;

FIG. 26E is a diagram schematically showing a passage configuration in a liquid ejection head;

FIG. 26F is a diagram schematically showing a passage configuration in a liquid ejection head;

FIG. 27A is a diagram schematically showing a circulation path in a first modification;

FIG. 27B is a diagram schematically showing a circulation path in the first modification;

FIG. 28A is a diagram schematically showing a circulation path in the first modification;

FIG. 28B is a diagram schematically showing a circulation path in the first modification;

FIG. 29A is a diagram schematically showing a circulation path in a second modification;

FIG. 29B is a diagram schematically showing a circulation path in the second modification;

FIG. 30A is a diagram schematically showing a circulation path in the second modification;

FIG. 30B is a diagram schematically showing a circulation path in the second modification;

FIG. 31 is a block diagram schematically showing a liquid circulation path;

FIG. 32 is a block diagram schematically showing a liquid circulation path;

FIG. 33 is a block diagram schematically showing a liquid circulation path;

FIG. 34 is a diagram schematically showing a circulation path in a fourth modification;

### DESCRIPTION OF THE EMBODIMENTS

### First Embodiment

Hereinafter, a first preferred embodiment of the present disclosure will be described in detail with reference to the accompanying drawings. It should be noted that the following embodiments do not limit the matters disclosed herein, and not all combinations of features described in the embodiments are essential to the solution of the present disclosure. Note that the same components are denoted by the same reference numerals. In the embodiments, an example of adopting a thermal method will be described, in which an electrothermal conversion element is used as an ejection element that ejects a liquid to generate bubbles and eject the liquid, but the present invention is not limited to this example. The present invention is also applicable to a liquid ejection head that employs an ejection method for ejecting a liquid using a piezoelectric element (piezo) or another ejection method. Furthermore, a pump, a pressure adjusting unit, and the like described below are not limited to configurations described in the embodiments and drawings. In the following description, the basic configuration of the present disclosure will be described first, and features of the present disclosure will be described.

### <Liquid Ejection Apparatus>

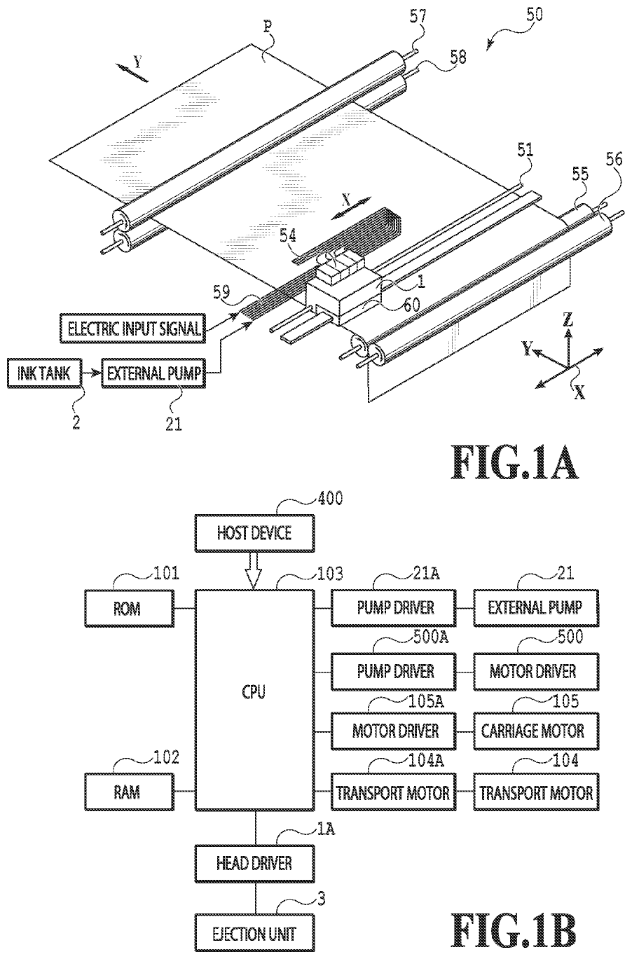

FIGS. 1A and 1B are diagrams for explaining a liquid ejection apparatus, showing enlarged views of a liquid ejection head of the liquid ejection apparatus and its surroundings. First, a schematic configuration of a liquid ejection apparatus 50 according to the present embodiment will be described with reference to FIGS. 1A and 1B. FIG. 1A is a perspective view schematically showing a liquid ejection apparatus capable of mounting a liquid ejection head 1. The liquid ejection apparatus 50 of the present embodiment constitutes a serial type ink jet printing apparatus for printing on a printing medium P by ejecting ink as a liquid while scanning the liquid ejection head 1.

The liquid ejection head 1 is mounted on a carriage 60. The carriage 60 reciprocally moves along a guide shaft 51 in a main scanning direction (X direction). The printing medium P is transported by transport rollers 55, 56, 57, and 58 in a sub-scanning direction (Y direction) that intersects with (in this example, orthogonal to) the main scanning direction. In the drawings referred to below, a Z direction represents a vertical direction and intersects with (in this example, orthogonal to) the X-Y plane defined by the X direction and the Y direction. The liquid ejection head 1 is configured to be attachable to and detachable from the carriage 60 by a user.

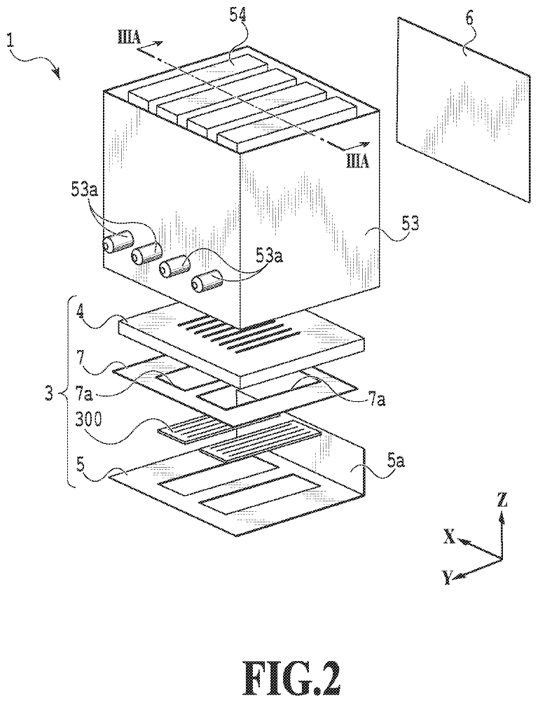

The liquid ejection head 1 includes a circulation unit 54 and an ejection unit 3 (see FIG. 2) to be described later. Although the specific configuration will be described later, the ejection unit 3 is provided with a plurality of ejection ports and an energy generation element (hereinafter referred to as an ejection element) that generates ejection energy for ejecting a liquid from each ejection port.

The liquid ejection apparatus 50 also includes an ink tank 2, which is an ink supply source, and an external pump 21. The ink stored in the ink tank 2 is supplied to the circulation unit 54 via an ink supply tube 59 by driving force of the external pump 21.

The liquid ejection apparatus 50 repeats print scanning in which the liquid ejection head 1 mounted on the carriage 60 performs printing by ejecting the ink while moving in the main scanning direction, and a transport operation for transporting the printing medium P in the sub-scanning direction, thereby forming a predetermined image on the printing medium P. The liquid ejection head 1 according to the present embodiment is capable of ejecting four types of inks: black (K), cyan (C), magenta (M), and yellow (Y), thus enabling printing of full-color images with these inks. However, the inks that can be ejected from the liquid ejection head 1 are not limited to the above four types of inks. The present disclosure is also applicable to liquid ejection heads for ejecting other types of inks. That is, the types and number of inks ejected from the liquid ejection head are not limited.

The liquid ejection apparatus 50 also includes a cap member (not shown) provided at a position shifted from a transport path of the printing medium P in the X direction. The cap member can cover the ejection port surface in which the ejection ports of the liquid ejection head are formed. The cap member covers the ejection port surface of the liquid ejection head 1 during non-print operation, and is used for protecting and preventing the ejection ports from drying, sucking the ink from the ejection ports, and the like.

Note that the liquid ejection head 1 shown in FIG. 1A is an example where the liquid ejection head 1 includes four circulation units 54 corresponding to the four types of inks, but only needs to include the circulation unit 54 corresponding to the type of liquid to be ejected. Alternatively, a plurality of circulation units 54 may be provided for the same type of liquid. That is, the liquid ejection head 1 can be configured to include one or more circulation units. A configuration may also be adopted in which only at least one ink is circulated, rather than all four types of inks.

FIG. 1B is a block diagram showing a control system of the liquid ejection apparatus 50. A CPU 103 functions as a control unit that controls operations of each part of the liquid ejection apparatus 50, based on programs such as processing procedures stored in a ROM 101. A RAM 102 is used as a work area or the like for the CPU 103 to execute processing. The CPU 103 receives image data from a host device 400 outside the liquid ejection apparatus 50 and controls a head driver 1A to control driving of ejection elements provided in the ejection unit 3. The CPU 103 also controls drivers for various actuators provided in the liquid ejection apparatus 50. For example, the CPU 103 controls a motor driver 105A of a carriage motor 105 for moving the carriage 60, a motor driver 104A of a transport motor 104 for transporting the printing medium P, and the like. The CPU 103 also controls a pump driver 500A that drives a circulation pump 500 to be described later, a pump driver 21A of the external pump 21, and the like. Although FIG. 1B shows a configuration in which processing is performed upon receiving image data from a host device 400, the liquid ejection apparatus 50 may perform processing regardless of data from the host device 400.

### <Basic Configuration of Liquid Ejection Head>

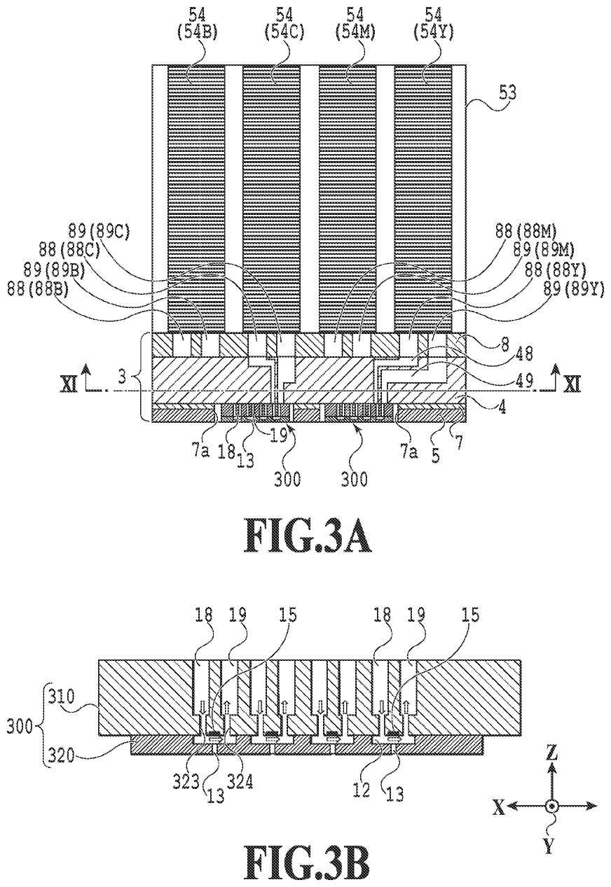

FIG. 2 is an exploded perspective view of the liquid ejection head 1 according to the present embodiment. FIG. 3A is a cross-sectional view taken along line IIIa-IIIa of the liquid ejection head 1 shown in FIG. 2. FIG. 3A is an overall vertical sectional view of the liquid ejection head 1. FIG. 3B is an enlarged view of an ejection module shown in FIG. 3A. The basic configuration of the liquid ejection head 1 according to the present embodiment will be described below mainly with reference to FIGS. 2 and 3, and also to FIG. 1 as appropriate.

As shown in FIG. 2, the liquid ejection head 1 includes the circulation unit 54 and the ejection unit 3 for ejecting ink supplied from the circulation unit 54 onto the printing medium P. The liquid ejection head 1 according to the present embodiment is fixedly supported by the carriage 60 of the liquid ejection apparatus 50, using positioning means and electric contact (not shown) provided on the carriage 60. The liquid ejection head 1 ejects ink while moving in the main scanning direction (X direction) shown in FIG. 1 together with the carriage 60 to perform printing on the printing medium P.

The ink supply tube 59 is provided in the external pump 21 connected to the ink tank 2 that serves as an ink supply source (see FIG. 1A). A liquid connector (not shown) is provided at the tip of the ink supply tube 59. As the liquid ejection head 1 is mounted on the liquid ejection apparatus 50, the liquid connector provided at the tip of the ink supply tube 59 is hermetically connected to a liquid connector insertion slot 53a provided as a liquid inlet in a head housing 53 of the liquid ejection head 1. An ink supply path is thus formed from the ink tank 2 to the liquid ejection head 1 through the external pump 21. In the present embodiment, since four types of inks are used, four sets of the ink tanks 2, external pumps 21, ink supply tubes 59, and circulation units 54 are provided corresponding to each ink. Four ink supply paths are formed independently, corresponding to each ink. The liquid ejection apparatus 50 of the present embodiment is thus equipped with an ink supply system to supply ink from the ink tank 2 provided outside the liquid ejection head 1. Note that the liquid ejection apparatus 50 of the present embodiment is not equipped with an ink collection system to collect the ink in the liquid ejection head 1 back into the ink tank 2. Therefore, the liquid ejection head 1 is provided with the liquid connector insertion slot 53a for connecting the ink supply tube 59 of the ink tank 2, but is not provided with a connector insertion slot for connecting a tube for collecting the ink from the liquid ejection head 1 into the ink tank 2. Note that the liquid connector insertion slot 53a is provided for each ink.

In FIG. 3A, reference numeral 54B denotes a circulation unit for black ink, reference numeral 54C denotes a circulation unit for cyan ink, reference numeral 54M denotes a circulation unit for magenta ink, and reference numeral 54Y denotes a circulation unit for yellow ink. Each circulation unit has substantially the same configuration. In the present embodiment, the circulation units will all be referred to as the circulation units 54 if not particularly differentiated from each other.

In FIGS. 2 and 3A, the ejection unit 3 includes two ejection modules 300, a first support member 4, a second support member 7, an electric wiring member (electric wiring tape) 5, and an electric contact substrate 6. As shown in FIG. 3B, the ejection module 300 includes a silicon substrate 310 having a thickness of 0.5 mm to 1 mm, and a plurality of ejection elements 15 provided on one side of the silicon substrate 310. The ejection element 15 in the present embodiment is configured using an electrothermal conversion element (heater) that generates thermal energy as ejection energy for ejecting a liquid. Each ejection element 15 receives power supplied through electric wiring formed on the silicon substrate 310 by a film formation technique.

An ejection port forming member 320 is formed on the surface of the silicon substrate 310 (lower surface in FIG. 3B). In the ejection port forming member 320, a plurality of pressure chambers 12 corresponding to the plurality of ejection elements 15 and a plurality of ejection ports 13 for ejecting ink are formed by photolithography. A common supply passage 18 and a common collection passage 19 are also formed in the silicon substrate 310. A supply connection flow path 323 that communicates the common supply passage 18 and each pressure chamber 12 and a collection connection flow path 324 that communicates the common collection passage 19 and each pressure chamber 12 are also formed in the silicon substrate 310. In the present embodiment, one ejection module 300 is configured to eject two types of inks. That is, one of the two ejection modules 300 shown in FIG. 3A, which is located on the left side of FIG. 3A, ejects black ink and cyan ink, and the ejection module 300 located on the right side of FIG. 3A ejects magenta ink and yellow ink. Note that this combination is just an example, and any combination of inks may be adopted. One ejection module may eject one type of ink, or may eject three or more types of inks. The two ejection modules 300 do not need to eject the same number of types of inks. The configuration may include one ejection module 300, or may include three or more ejection modules 300. Furthermore, in the example shown in FIGS. 3A and 3B, two ejection port arrays extending in the Y direction are formed for one ink color. The pressure chamber 12, the common supply passage 18, and the common collection passage 19 are formed for each of the plurality of ejection ports 13 included in each ejection port array.

An ink supply port and an ink collection port, which will be described later, are formed on the back surface (upper surface in FIG. 3B) of the silicon substrate 310. The ink supply port supplies ink from an ink supply passage 48 to the plurality of common supply passages 18. The ink collection port collects ink from the plurality of common collection passages 19 to an ink collection passage 49.

Note that the ink supply port and ink collection port herein refer to openings for supplying and collecting ink during ink circulation in a forward direction to be described later. That is, during ink circulation in the forward direction, ink is supplied from the ink supply port to each common supply passage 18, and ink is collected from each common collection passage 19 to the ink collection port. However, ink circulation may be performed in which the ink flows in the opposite direction. In this case, ink is supplied from the ink collection port described above to the common collection passage 19, and ink is collected from the common supply passage 18 to the ink supply port.

As shown in FIG. 3A, the back surface (upper surface in FIG. 3A) of the ejection module 300 is adhesively fixed to one surface (lower surface in FIG. 3A) of the first support member 4. The first support member 4 has the ink supply passage 48 and ink collection passage 49 formed therein, which penetrate from one surface to the other surface of the first support member. One opening of the ink supply passage 48 is communicated with the ink supply port described above in the silicon substrate 310, and one opening of the ink collection passage 49 is communicated with the ink collection port described above in the silicon substrate 310. Note that the ink supply passage 48 and the ink collection passage 49 are provided independently for each ink type.

The second support member 7 having an opening 7a (see FIG. 2), into which the ejection module 300 is inserted, is adhesively fixed to one surface (upper surface in FIG. 3A) of the first support member 4. The second support member 7 holds an electric wiring member 5 that is electrically connected to the ejection module 300. The electric wiring member 5 is a member for applying an electric signal to the ejection module 300 for ejecting ink. The electrical connection between the ejection module 300 and the electric wiring member 5 is sealed with a sealant (not shown) and thus protected from corrosion by ink and external impact.

The electric contact substrate 6 is thermocompression bonded to an end portion 5a (see FIG. 2) of the electric wiring member 5, using an anisotropic conductive film (not shown). The electric wiring member 5 and the electric contact substrate 6 are electrically connected to each other. The electric contact substrate 6 has an external signal input terminal (not shown) for receiving electric signals from the liquid ejection apparatus 50.

A joint member 8 (see FIG. 3A) is provided between the first support member 4 and the circulation unit 54. A supply port 88 and a collection port 89 are formed in the joint member 8 for each ink type. The supply port 88 and the collection port 89 communicate the ink supply passage 48 and the ink collection passage 49 in the first support member 4 with the passage formed in the circulation unit 54. In FIG. 3A, a supply port 88B and a collection port 89B correspond to black ink, and a supply port 88C and a collection port 89C correspond to cyan ink. A supply port 88M and a collection port 89M correspond to magenta ink, and a supply port 88Y and a collection port 89Y correspond to yellow ink.

Note that the openings at one ends of the ink supply passage 48 and the ink collection passage 49 in the first support member 4 have a small opening area that matches the ink supply port and ink collection port in the silicon substrate 310. On the other hand, the openings at the other ends of the ink supply passage 48 and the ink collection passage 49 in the first support member 4 have a shape expanded to the same opening area as a large opening area of the joint member 8 formed to match the passage in the circulation unit 54. Such a configuration makes it possible to suppress an increase in passage resistance to the ink collected from each collection passage. However, the shapes of the openings at one end and the other end of the ink supply passage 48 and the ink collection passage 49 are not limited to the above example.

In the liquid ejection head 1 having the above configuration, the ink supplied to the circulation unit 54 passes through the supply port 88 of the joint member 8 and the ink supply passage 48 of the first support member 4, and flows into the common supply passage 18 from the ink supply port of the ejection module 300. The ink then flows into the pressure chamber 12 from the common supply passage 18 through the supply connection flow path 323. Some of the ink flowing into the pressure chamber is ejected from the ejection port 13 by driving the ejection element 15. The remaining ink that was not ejected flows into the ink collection passage 49 of the first support member 4 through the ink collection port from the pressure chamber 12 through the collection connection flow path 324 and the common collection passage 19. The ink flowing into the ink collection passage 49 is then collected after flowing into the circulation unit 54 through the collection port 89 of the joint member 8.

### <Components of Circulation Unit>

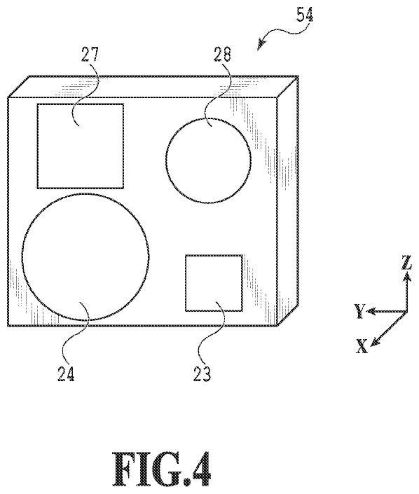

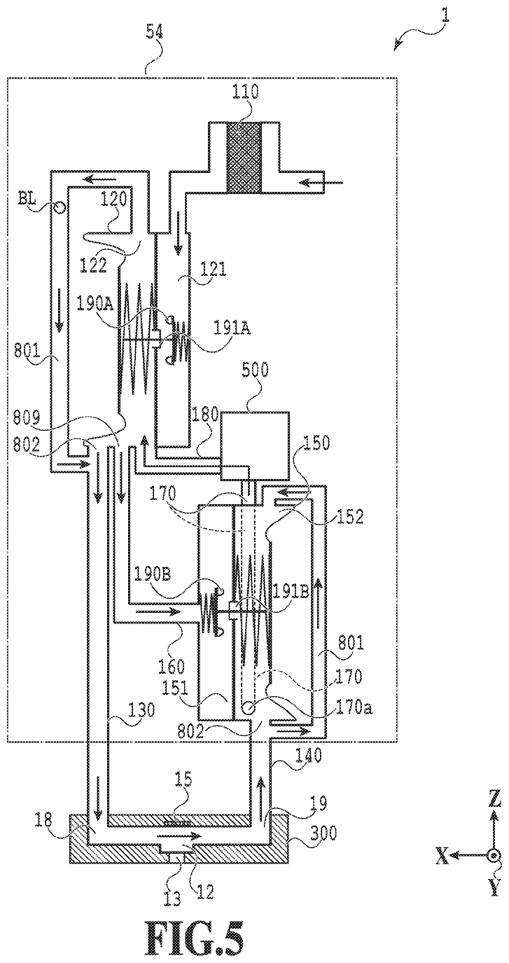

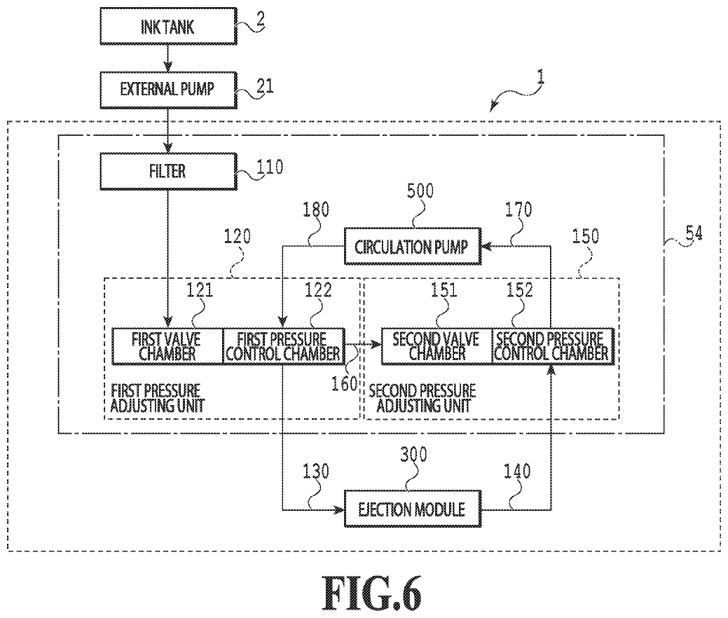

FIG. 4 is a schematic external view of one circulation unit 54 corresponding to one type of ink applied to the printing apparatus of the present embodiment. A filter 110, a first pressure adjusting unit 120, a second pressure adjusting unit 150, and a circulation pump 500 are disposed in the circulation unit 54. These components are connected by respective passages as shown in FIGS. 5 and 6, and constitute a circulation path for supplying and collecting ink to and from the ejection module 300 within the liquid ejection head 1.

### <Circulation Path Inside Liquid Ejection Head>

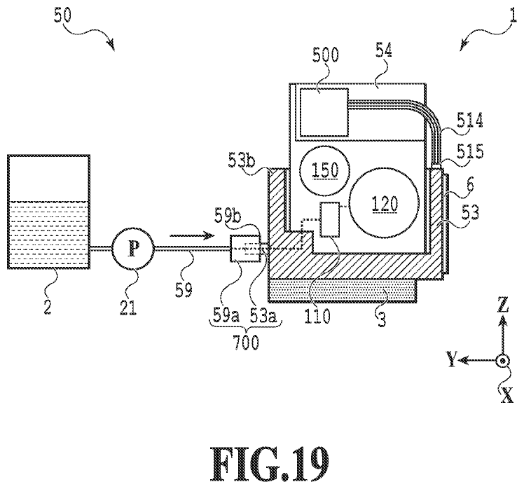

FIG. 5 is a vertical sectional view schematically showing a circulation path for one type of ink (one ink color) formed in the liquid ejection head 1. To explain the circulation path more clearly, the relative positions of the components (the first pressure adjusting unit 120, the second pressure adjusting unit 150, the circulation pump 500, and the like) in FIG. 5 are simplified. Therefore, the relative positions of the components are different from those shown in FIG. 19 to be described later. FIG. 6 is a block diagram schematically showing the circulation path shown in FIG. 5. As shown in FIGS. 5 and 6, the first pressure adjusting unit 120 includes a first valve chamber 121 and a first pressure adjusting chamber 122. The second pressure adjusting unit 150 includes a second valve chamber 151 and a second pressure adjusting chamber 152. The first pressure adjusting unit 120 is configured to have a relatively higher control pressure than the second pressure adjusting unit 150. In the present embodiment, these two pressure adjusting units 120 and 150 are used to realize circulation within a certain pressure range through the circulation path. The circulation path is also configured such that the ink flows through the pressure chamber 12 (ejection element 15) at a flow rate corresponding to a pressure difference between the first pressure adjusting unit 120 and the second pressure adjusting unit 150. The circulation path in the liquid ejection head 1 and the flow of ink through the circulation path will be described below with reference to FIGS. 5 and 6. The arrows in FIGS. 5 and 6 indicate the direction in which the ink flows.

A first discharge passage 801 and a second discharge passage 802 are connected to the first pressure adjusting chamber 122, respectively. The first discharge passage 801 and the second discharge passage 802 are connected to a supply passage 130. A third discharge passage 809 is provided at the bottom of the first pressure adjusting chamber 122 and is communicated with a third discharge port 810 and further communicated with a bypass passage 160. These will be described in detail later.

First, a description is given of how the components are connected in the liquid ejection head 1.

The external pump 21 that feeds the ink stored in the ink tank 2 (FIG. 6) provided outside the liquid ejection head 1 to the liquid ejection head 1 is connected to the circulation unit 54 through the ink supply tube 59 (FIG. 1). The filter 110 is provided in an ink passage positioned on the upstream side of the circulation unit 54. An ink passage positioned on the downstream side of the filter 110 is connected to the first valve chamber 121 of the first pressure adjusting unit 120. The first valve chamber 121 is communicated with the first pressure adjusting chamber 122 through a communication port 191A that can be opened and closed by a valve 190A shown in FIG. 5.

The first pressure adjusting chamber 122 is connected to the supply passage 130, the bypass passage 160, and a pump outlet passage 180 of the circulation pump 500. The supply passage 130 is connected to the common supply passage 18 through the ink supply port described above, which is provided in the ejection module 300. The bypass passage 160 is connected to the second valve chamber 151 provided in the second pressure adjusting unit 150. The second valve chamber 151 is communicated with the second pressure adjusting chamber 152 through a communication port 191B that is opened and closed by a valve 190B shown in FIG. 5. FIGS. 5 and 6 show an example where one end of the bypass passage 160 is connected to the first pressure adjusting chamber 122 of the first pressure adjusting unit 120, and the other end of the bypass passage 160 is connected to the second valve chamber 151 of the second pressure adjusting unit 150. However, one end of the bypass passage 160 may be connected to the supply passage 130 and the other end of the bypass passage may be connected to the second valve chamber 151.

The second pressure adjusting chamber 152 is connected to a collection passage 140. The collection passage 140 is connected to the common collection passage 19 through the ink collection port described above, which is provided in the ejection module 300. The second pressure adjusting chamber 152 is also connected to the circulation pump 500 through a pump inlet passage 170. In FIG. 5, reference numeral 170a denotes an inlet port of the pump inlet passage 170.

Next, the flow of ink in the liquid ejection head 1 having the above configuration will be described. As shown in FIG. 6, the ink stored in the ink tank 2 is pressurized by the external pump 21 provided in the liquid ejection apparatus 50, and is supplied as a positive pressure ink flow to the circulation unit 54 in the liquid ejection head 1.

The ink supplied to the circulation unit 54 passes through the filter 110 to remove foreign substances such as dust and air bubbles, and then flows into the first valve chamber 121 provided in the first pressure adjusting unit 120. Although the pressure of the ink decreases due to pressure loss in a case of passing through the filter 110, the pressure of the ink at this stage is in a positive pressure state. Thereafter, the ink flowing into the first valve chamber 121 passes through the communication port 191A and flows into the first pressure adjusting chamber 122 in a case where the valve 190A is in its open state. Due to the pressure loss in a case of passing through the communication port 191A, the ink flowing into the first pressure adjusting chamber 122 switches from positive pressure to negative pressure.

Next, the ink flow within the circulation path will be described. The circulation pump 500 operates to send ink sucked from the pump inlet passage 170 on the upstream side to the pump outlet passage 180 on the downstream side. Therefore, by driving the pump, the ink supplied to the first pressure adjusting chamber 122 flows into the supply passage 130 and the bypass passage 160 together with the ink sent from the pump outlet passage 180. Although described in detail later, a piezoelectric diaphragm pump whose driving source is a piezoelectric element attached to a diaphragm is used in the present embodiment as a circulation pump capable of feeding a liquid. The piezoelectric diaphragm pump is a pump that changes the volume inside a pump chamber by inputting a drive voltage to a piezoelectric element, and feeds a liquid by two check valves alternately moving due to pressure fluctuations.

The ink flowing into the supply passage 130 flows from the ink supply port of the ejection module 300 into the pressure chamber 12 through the common supply passage 18, and some of the ink is ejected from the ejection port 13 by driving the ejection element 15 (heat generation). Further, the remaining ink not used for ejection flows through the pressure chamber 12 and passes through the common collection passage 19 before flowing into the collection passage 140 connected to the ejection module 300. The ink flowing into the collection passage 140 flows into the second pressure adjusting chamber 152 in the second pressure adjusting unit 150.

On the other hand, the ink flowing into the bypass passage 160 from the first pressure adjusting chamber 122 flows into the second valve chamber 151 and then flows into the second pressure adjusting chamber 152 through the communication port 191B. The ink flowing into the second pressure adjusting chamber 152 via the bypass passage 160 and the ink collected from the collection passage 140 are sucked into the circulation pump 500 through the pump inlet passage 170 by driving the circulation pump 500. The ink sucked into the circulation pump 500 is then sent to the pump outlet passage 180 and flows into the first pressure adjusting chamber 122 again. Hereinafter, the ink flowing from the first pressure adjusting chamber 122 into the second pressure adjusting chamber 152 via the supply passage 130 and the ejection module 300 and the ink flowing into the second pressure adjusting chamber 152 through the bypass passage 160 flow into the circulation pump 500. The ink is then sent from the circulation pump 500 to the first pressure adjusting chamber 122. The ink is thus circulated within the circulation path.

Here, the passage that communicates the first pressure adjusting unit 120 and the pressure chamber 12 is referred to as a first passage, and the passage that communicates the pressure chamber 12 and the circulation pump 500 is referred to as a second passage. That is, the supply passage 130 is referred to as the first passage, and the collection passage 140, the second pressure adjusting unit 150, and the pump inlet passage 170 are collectively referred to as the second passage. Note that the second passage does not need to include the second pressure adjusting unit 150 and the pump inlet passage 170. The pump outlet passage 180 is also referred to as a third passage. Therefore, in the present embodiment, the liquid flows through the circulation pump 500, the third passage, the first pressure adjusting unit 120, the first passage, the pressure chamber 12, the second passage, and the circulation path of the circulation pump 500 in this order.

As described above, in the present embodiment, the circulation pump 500 makes it possible to circulate the liquid along the circulation path formed inside the liquid ejection head 1. This makes it possible to suppress the thickening of the ink and the accumulation of sedimentary components of the colorant ink in the ejection module 300, and to maintain good fluidity of the ink in the ejection module 300 and good ejection characteristics at the ejection port.

The circulation path in the present embodiment is configured to be completed within the liquid ejection head 1. This makes it possible to significantly shorten the length of the circulation path compared to the case where the ink is circulated between the liquid ejection head 1 and the ink tank 2 provided outside the liquid ejection head. The ink can thus be circulated using a small circulation pump.

The connection flow path between the liquid ejection head 1 and the ink tank 2 is configured to include only a passage for supplying ink. That is, a configuration is adopted which does not require a passage for collecting the ink from the liquid ejection head 1 to the ink tank 2. Therefore, it is only necessary to provide an ink supply tube for connection between the ink tank 2 and the liquid ejection head 1, and there is no need to provide an ink collection tube. Therefore, the liquid ejection apparatus 50 can have a simple internal configuration with a reduced number of tubes, and the entire apparatus can be downsized. Furthermore, such a reduction in the number of tubes makes it possible to reduce ink pressure fluctuations caused by the swinging of the tubes as the liquid ejection head 1 performs main scanning. Such swinging of the tubes during main scanning of the liquid ejection head 1 becomes a driving load on the carriage motor that drives the carriage 60. Therefore, the reduction in the number of tubes makes it possible to reduce the driving load on the carriage motor, and to simplify the main scanning mechanism including the carriage motor and the like. Since there is no need to collect ink from the liquid ejection head to the ink tank, the external pump 21 can also be downsized. Therefore, according to the present embodiment, downsizing and cost reduction of the liquid ejection apparatus 50 can be achieved.

### <Pressure Adjusting Unit>

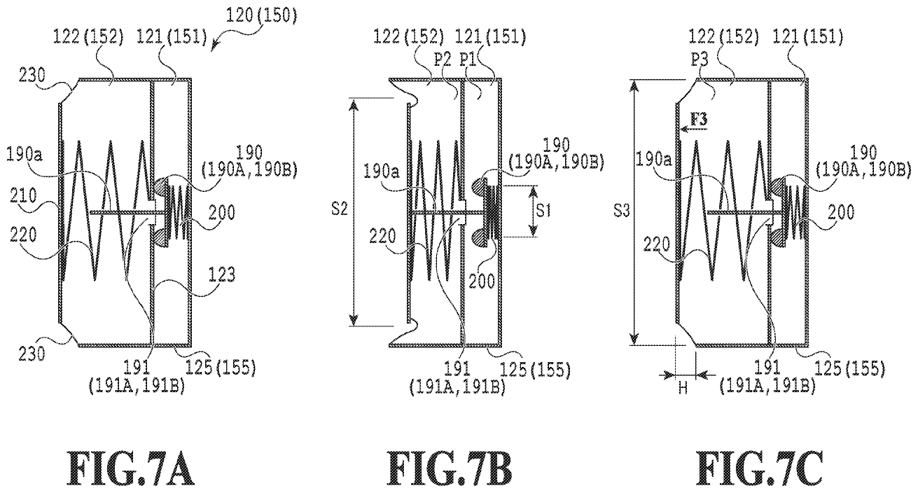

FIGS. 7A to 7C are diagrams showing an example of the pressure adjusting unit. The configuration and operations of the pressure adjusting unit (the first pressure adjusting unit 120 and the second pressure adjusting unit 150) built into the above-mentioned liquid ejection head 1 will be described in more detail with reference to FIGS. 7A to 7C. Note that the first pressure adjusting unit 120 and the second pressure adjusting unit 150 have substantially the same configuration. Therefore, in the following description, the first pressure adjusting unit 120 will be described as an example. As for the second pressure adjusting unit 150, reference numerals will only be given in FIGS. 7A to 7C to denote the parts corresponding to those of the first pressure adjusting unit. In the case of the second pressure adjusting unit 150, the first valve chamber 121 described below is replaced with the second valve chamber 151 and the first pressure adjusting chamber 122 is replaced with the second pressure adjusting chamber 152.

The first pressure adjusting unit 120 has the first valve chamber 121 and the first pressure adjusting chamber 122 formed in a cylindrical housing 125. The first valve chamber 121 and the first pressure adjusting chamber 122 are separated by a partition 123 provided inside the cylindrical housing 125. The first valve chamber 121 is communicated with the first pressure adjusting chamber 122 through the communication port 191 formed in the partition 123. The first valve chamber 121 is provided with a valve 190 that switches communication and shut-off between the first valve chamber 121 and the first pressure adjusting chamber 122 at the communication port 191. The valve 190 is held in a position facing the communication port 191 by a valve spring 200 and is configured to come into close contact with the partition 123 by the biasing force of the valve spring 200. The valve 190 coming into close contact with the partition 123 shuts off the flow of ink through the communication port 191. To improve the close contact with the partition 123, the contact portion of the valve 190 with the partition 123 is preferably formed of an elastic member. A valve shaft 190a that is inserted into the communication port 191 is provided projecting from the center of the valve 190. This valve shaft 190a is pressed against the biasing force of the valve spring 200 to separate the valve 190 from the partition 123, thereby allowing ink to flow through the communication port 191. Hereinafter, a state where the ink flow through the communication port 191 is shut off by the valve 190 will be referred to as a “closed state,” and a state where the ink can flow through the communication port 191 will be referred to as an “open state.”

The opening of the cylindrical housing 125 is closed by a flexible member 230 and a pressing plate 210. The first pressure adjusting chamber 122 is formed by the flexible member 230, the pressing plate 210, a peripheral wall of the housing 125, and the partition 123. The volume of the first pressure adjusting chamber 122 can be changed, and the pressing plate 210 is configured to be displaceable in accordance with the displacement of the flexible member 230. The materials of the pressing plate 210 and the flexible member 230 are not particularly limited. For example, the pressing plate 210 can be made of a resin molded part, and the flexible member 230 can be made of a resin film. In this case, the pressing plate 210 can be fixed to the flexible member 230 by thermal welding.

A pressure adjustment spring 220 (biasing member) is provided between the pressing plate 210 and the partition 123. The biasing force of the pressure adjustment spring 220 biases the pressing plate 210 and the flexible member 230 in a direction to increase the inner volume of the first pressure adjusting chamber 122, as shown in FIG. 7A. As the pressure inside the first pressure adjusting chamber 122 decreases, the pressing plate 210 and the flexible member 230 are displaced, against the pressure of the pressure adjustment spring 220, in a direction to reduce the inner volume of the first pressure adjusting chamber 122. As the inner volume of the first pressure adjusting chamber 122 decreases to a certain amount, the pressing plate 210 comes into contact with the valve shaft 190a of the valve 190. Thereafter, as the inner volume of the first pressure adjusting chamber 122 further decreases, the valve 190 moves together with the valve shaft 190a against the biasing force of the valve spring 200 and separates from the partition 123. The communication port 191 is thus set in the open state (the state shown in FIG. 7B).

In the present embodiment, the connections within the circulation path are set so that the pressure in the first valve chamber 121 is higher than the pressure in the first pressure adjusting chamber 122 in a case where the communication port 191 is in the open state. Once the communication port 191 is set in the open state, ink flows from the first valve chamber 121 to the first pressure adjusting chamber 122. This ink inflow displaces the flexible member 230 and the pressing plate 210 in the direction to increase the inner volume of the first pressure adjusting chamber 122. As a result, the pressing plate 210 separates from the valve shaft 190a of the valve 190, and the biasing force of the valve spring 200 brings the valve 190 into close contact with the partition 123, thus setting the communication port 191 in the closed state (the state shown in FIG. 7C).

In the first pressure adjusting unit 120 according to the present embodiment, as the pressure in the first pressure adjusting chamber 122 decreases to a certain pressure or less (for example, when the negative pressure increases), the ink flows from the first valve chamber 121 through the communication port 191. This prevents the pressure in the first pressure adjusting chamber 122 from decreasing any further. Therefore, the pressure in the first pressure adjusting chamber 122 is controlled to be maintained within a certain range.

Next, the pressure in the first pressure adjusting chamber 122 will be described in more detail.

A situation is considered where, as described above, the flexible member 230 and the pressing plate 210 are displaced according to the pressure in the first pressure adjusting chamber 122, and the pressing plate 210 comes into contact with the valve shaft 190a, thus setting the communication port 191 in the open state (the situation shown in FIG. 7B). In this situation, the relationship between the forces acting on the pressing plate 210 is expressed by Formula 1 below.

$$P 2 \times S 2 + F 2 + ( P 1 - P 2 ) \times S 1 + F 1 = 0 \qquad Formula 1$$

Formula 1 is further rearranged with respect to P2 to obtain Formula 2 below.

$$P 2 = - ( F 1 + F 2 + P 1 \times S 1 ) / ( S 2 - S 1 ) \qquad Formula 2$$

P1: Pressure in first valve chamber 121 (gauge pressure)
P2: Pressure in first pressure adjusting chamber 122 (gauge pressure)
F1: Spring force of valve spring 200
F2: Spring force of pressure adjustment spring 220
S1: Pressure receiving area of valve 190
S2: Pressure receiving area of pressing plate 210

Here, the spring force F1 of the valve spring 200 and the spring force F2 of the pressure adjustment spring 220 push the valve 190 and the pressing plate 210 in a positive direction (to the left in FIGS. 7A to 7C). As for the pressure P1 in the first valve chamber 121 and the pressure P2 in the first pressure adjusting chamber 122, the configuration is such that P1 satisfies the relationship P1≥P2.

The pressure P2 in the first pressure adjusting chamber 122 with the communication port 191 in the open state is determined by Formula 2. As the communication port 191 is set in the open state, the ink flows from the first valve chamber 121 to the first pressure adjusting chamber 122 as the configuration satisfies the relationship P1≥P2. As a result, the pressure P2 in the first pressure adjusting chamber 122 does not decrease any further and is maintained within a certain range.

On the other hand, as shown in FIG. 7C, in a case where the pressing plate 210 is in a noncontact state with the valve shaft 190a and the communication port 191 is in the closed state, the relationship between the forces acting on the pressing plate 210 is as shown in Formula 3.

$$P 3 \times S 3 + F 3 = 0 \qquad Formula 3$$

Here, Formula 3 is rearranged with respect to P3 to obtain Formula 4 below.

$$P 3 = - F 3 / S 3 \qquad Formula 4$$

F3: Spring force of the pressure adjustment spring 220 in a case where the pressing plate 210 and the valve shaft 190a are in the noncontact state
P3: Pressure (gauge pressure) in the first pressure adjusting chamber 122 in a case where the pressing plate 210 and the valve shaft 190a are in the noncontact state
S3: Pressure receiving area of the pressing plate 210 in a case where the pressing plate 210 and the valve 190 are in the noncontact state

Here, FIG. 7C shows a state where the pressing plate 210 and the flexible member 230 are displaced to the right in FIG. 7C to the limit of displacement. The pressure P3 in the first pressure adjusting chamber 122, the spring force F3 of the pressure adjustment spring 220, and the pressure receiving area S3 of the pressing plate 210 change depending on the amount of displacement while the pressing plate 210 and the flexible member 230 are displaced to the state shown in FIG. 7C. Specifically, if the pressing plate 210 and the flexible member 230 are further to the left in FIG. 7 than in FIG. 7C, the pressure receiving area S3 of the pressing plate 210 decreases and the spring force F3 of the pressure adjustment spring 220 increases. As a result, the pressure P3 in the first pressure adjusting chamber 122 decreases based on the relationship of Formula 4. Therefore, according to Formulas 2 and 4, the pressure in the first pressure adjusting chamber 122 gradually increases from the state of FIG. 7B to the state of FIG. 7C (that is, the negative pressure decreases and approaches a value on the positive pressure side). Specifically, the pressing plate 210 and the flexible member 230 are gradually displaced to the right from the state where the communication port 191 is in the open state, and the pressure in the first pressure adjusting chamber gradually increases until the inner volume of the first pressure adjusting chamber 122 finally reaches its limit for the displacement. In other words, the negative pressure decreases. In the present embodiment, the first pressure adjusting unit 120 adjusts the pressure of the liquid in the first passage, and the second pressure adjusting unit 150 adjusts the pressure of the liquid in the pump inlet passage 170 (in the inlet passage).

### <Circulation Pump>

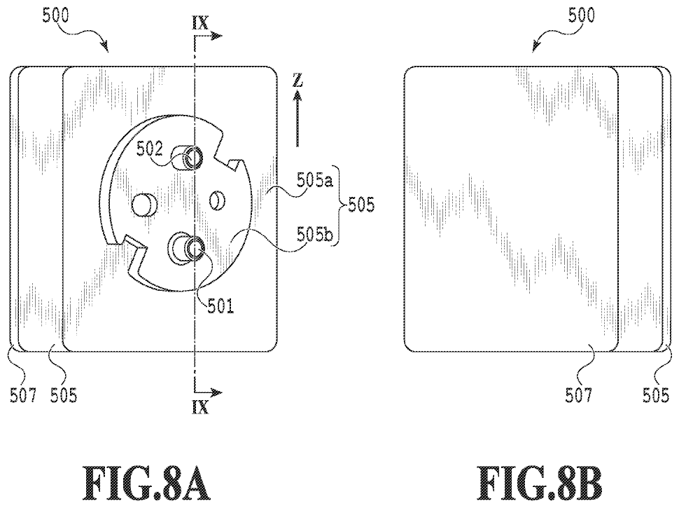

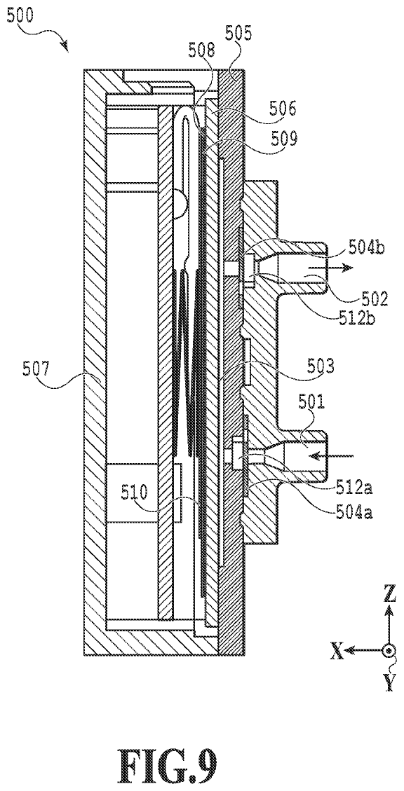

Next, the configuration and operations of the circulation pump 500 built into the above-mentioned liquid ejection head 1 will be described in detail with reference to FIGS. 8A, 8B, and 9.

FIGS. 8A and 8B are external perspective views of the circulation pump 500. FIG. 8A is an external perspective view showing the front side of the circulation pump 500. FIG. 8B is an external perspective view showing the back side of the circulation pump 500. The outer shell of the circulation pump 500 is composed of a pump housing 505 and a cover 507 fixed to the pump housing 505. The pump housing 505 includes a housing main body 505a and a passage connecting member 505b adhesively fixed to the outer surface of the housing main body 505a. A pair of through-holes communicated with each other are provided at two different positions in each of the housing main body 505a and the passage connecting member 505b. The pair of through-holes provided at one position form a pump supply hole 501, and the pair of through-holes provided at the other position form a pump discharge hole 502. The pump supply hole 501 is connected to the pump inlet passage 170 connected to the second pressure adjusting chamber 152, and the pump discharge hole 502 is connected to the pump outlet passage 180 connected to the first pressure adjusting chamber 122. The ink supplied through the pump supply hole 501 passes through a pump chamber 503 (see FIG. 9) to be described later, and is ejected through the pump discharge hole 502.

FIG. 9 is a cross-sectional view taken along line IX-IX of the circulation pump 500 shown in FIG. 8A. A diaphragm 506 is attached to the inner surface of the pump housing 505. The pump chamber 503 is formed between the diaphragm 506 and a recess formed on the inner surface of the pump housing 505. The pump chamber 503 is communicated with the pump supply hole 501 and the pump discharge hole 502 formed in the pump housing 505. A check valve 504a is provided at the middle portion of the pump supply hole 501, and a check valve 504b is provided at the middle portion of the pump discharge hole 502. That is, the circulation pump 500 includes the check valves in the passage that communicates the second passage and the third passage. Specifically, the check valve 504a is disposed such that a portion thereof can move to the left in FIG. 9 in a space 512a formed in the middle portion of the pump supply hole 501. Likewise, the check valve 504b is disposed such that a portion thereof can move to the right in FIG. 9 in a space 512b formed in the middle portion of the pump discharge hole 502.

As the pump chamber 503 is depressurized by increasing the volume of the pump chamber 503 through displacement of the diaphragm 506, the check valve 504a separates from the opening of the pump supply hole 501 in the space 512a (that is, moves to the left in FIG. 9). The check valve 504a separating from the opening of the pump supply hole 501 in the space 512a leads to the open state where the ink can flow through the pump supply hole 501. On the other hand, as the pump chamber 503 is pressurized by reducing the volume of the pump chamber 503 through displacement of the diaphragm 506, the check valve 504a comes into close contact with the wall surface around the opening of the pump supply hole 501. This leads to the closed state where the ink flow through the pump supply hole 501 is shut off.

As the pump chamber 503 is depressurized, the check valve 504b comes into close contact with the wall surface around the opening of the pump housing 505, leading to the closed state where the ink flow through the pump discharge hole 502 is shut off. On the other hand, as the pump chamber 503 is pressurized, the check valve 504b separates from the opening of the pump housing 505 and moves toward the space 512b (that is, moves to the right in FIG. 9), thus allowing the ink to flow through the pump discharge hole 502.

The check valves 504a and 504b may be formed of any material that can be deformed according to the pressure inside the pump chamber 503. For example, the check valves 504a and 504b may be made of an elastic member such as EPDM or elastomer, or a polypropylene film or thin plate, but are not limited thereto.

As described above, the pump chamber 503 is formed by joining the pump housing 505 and the diaphragm 506. Therefore, the pressure in the pump chamber 503 changes as the diaphragm 506 deforms. For example, as the diaphragm 506 is displaced toward the pump housing 505 (displaced to the right in FIG. 9) and the volume of the pump chamber 503 decreases, the pressure in the pump chamber 503 increases. This sets the check valve 504b disposed facing the pump discharge hole 502 in the open state, and the ink in the pump chamber 503 is ejected. In this event, the check valve 504a disposed facing the pump supply hole 501 is in close contact with the wall surface around the pump supply hole 501, thus suppressing backflow of ink from the pump chamber 503 into the pump supply hole 501.

In a case where the diaphragm 506 is displaced in the direction to expand the pump chamber 503, on the other hand, the pressure in the pump chamber 503 decreases. This sets the check valve 504a disposed facing the pump supply hole 501 in the open state, and the ink is supplied to the pump chamber 503. In this event, the check valve 504b disposed in the pump discharge hole 502 comes into close contact with the wall surface around the opening formed in the pump housing 505 to close the opening. This suppresses the backflow of ink from the pump discharge hole 502 into the pump chamber 503.

The circulation pump 500 thus sucks and discharges ink by deforming the diaphragm 506 and changing the pressure in the pump chamber 503. In this event, if bubbles are mixed into the pump chamber 503, expansion and contraction of the bubbles reduce the pressure change in the pump chamber 503, resulting in a decrease in the liquid feed amount, even if the diaphragm 506 is displaced. Therefore, the pump chamber 503 is disposed parallel to gravity so that the bubbles mixed in the pump chamber 503 can easily gather in the upper part of the pump chamber 503, and the pump discharge hole 502 is disposed above the center of the pump chamber 503. This makes it possible to improve the ability to discharge bubbles inside the pump, thereby stabilizing the flow rate.

### <Ink Flow Inside Liquid Ejection Head>

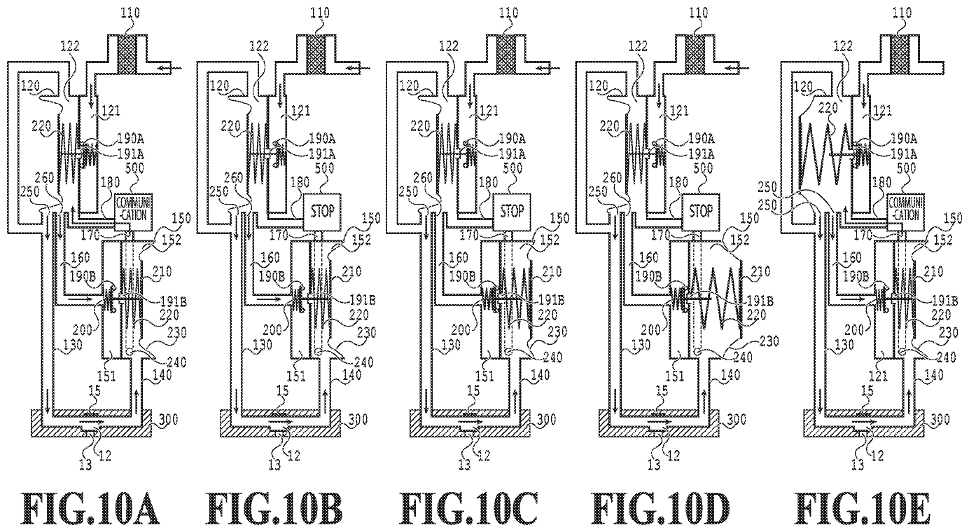

FIGS. 10A to 10E are diagrams illustrating an ink flow inside the liquid ejection head. The ink circulation performed inside the liquid ejection head 1 will be described with reference to FIGS. 10A to 10E. To explain the ink circulation path more clearly, the relative positions of the components (the first pressure adjusting unit 120, the second pressure adjusting unit 150, the circulation pump 500, and the like) in FIGS. 10A to 10E are simplified. Therefore, the relative positions of the components are different from those of FIG. 19 to be described later. FIG. 10A schematically shows the ink flow during a print operation in which ink is ejected from the ejection ports 13 to perform printing. Note that the arrows in FIG. 10A indicate the ink flow. In the present embodiment, both the external pump 21 and the circulation pump 500 start to be driven to perform the print operation. Note that the external pump 21 and the circulation pump 500 may be driven regardless of the print operation. Alternatively, the external pump 21 and the circulation pump 500 do not need to be driven in conjunction with each other, but may be driven separately and independently of each other.

During the print operation, the circulation pump 500 is in an ON state (driving state), and the ink flowing out of the first pressure adjusting chamber 122 flows into the supply passage 130 and the bypass passage 160. The ink flowing into the supply passage 130 flows into the collection passage 140 after passing through the ejection module 300, and is then supplied to the second pressure adjusting chamber 152.

On the other hand, the ink flowing into the bypass passage 160 from the first pressure adjusting chamber 122 flows into the second pressure adjusting chamber 152 via the second valve chamber 151. The ink flowing into the second pressure adjusting chamber 152 passes through the pump inlet passage 170, the circulation pump 500, and the pump outlet passage 180, and then flows into the first pressure adjusting chamber 122 again. In this event, the control pressure of the first valve chamber 121 is set higher than the control pressure of the first pressure adjusting chamber 122, based on the relationship of Formula 2 described above. Therefore, the ink in the first pressure adjusting chamber 122 does not flow through the first valve chamber 121, but is supplied to the ejection module 300 again through the supply passage 130. The ink flowing into the ejection module 300 passes through the collection passage 140, the second pressure adjusting chamber 152, the pump inlet passage 170, the circulation pump 500, and the pump outlet passage 180, and then flows into the first pressure adjusting chamber 122 again. The ink circulation is thus completed inside the liquid ejection head 1.

In the above ink circulation, the ink circulation amount (flow rate) within the ejection module 300 is determined by the difference in control pressure between the first pressure adjusting chamber 122 and the second pressure adjusting chamber 152. This differential pressure is set to obtain a circulation amount that can suppress thickening of ink near the ejection ports in the ejection module 300. The ink consumed by printing is supplied from the ink tank 2 to the first pressure adjusting chamber 122 through the filter 110 and the first valve chamber 121. The mechanism for supplying the consumed ink will be described in detail. As the ink in the circulation path decreases by the amount of ink consumed by printing, the pressure in the first pressure adjusting chamber decreases, resulting in a decrease in the amount of ink in the first pressure adjusting chamber 122. As the amount of ink in the first pressure adjusting chamber 122 decreases, the inner volume of the first pressure adjusting chamber 122 decreases. This decrease in the inner volume of the first pressure adjusting chamber 122 sets the communication port 191A in the open state, and the ink is supplied from the first valve chamber 121 to the first pressure adjusting chamber 122. The supplied ink undergoes pressure loss as it passes through the communication port 191A from the first valve chamber 121. The positive pressure ink switches to a negative pressure state as it flows into the first pressure adjusting chamber 122. Then, as the ink flows into the first pressure adjusting chamber 122 from the first valve chamber 121, the pressure in the first pressure adjusting chamber increases, and the inner volume of the first pressure adjusting chamber increases, thus setting the communication port 191A in the closed state. The communication port 191A repeats the open state and the closed state depending on the consumption of the ink. If no ink is consumed, the communication port 191A is kept in the closed state.

FIG. 10B schematically shows the ink flow immediately after the print operation is completed and the circulation pump 500 is turned off (stopped). When the print operation is completed and the circulation pump 500 is turned off, the pressure in the first pressure adjusting chamber 122 and the pressure in the second pressure adjusting chamber 152 are both set to the control pressures during the print operation. Therefore, the ink moves as shown in FIG. 10B according to the pressure difference between the pressure in the first pressure adjusting chamber 122 and the pressure in the second pressure adjusting chamber 152. Specifically, the ink is supplied from the first pressure adjusting chamber 122 to the ejection module 300 through the supply passage 130, and then continues to flow to the second pressure adjusting chamber 152 through the collection passage 140. The ink also continues to flow from the first pressure adjusting chamber 122 to the second pressure adjusting chamber 152 through the bypass passage 160 and the second valve chamber 151.

The amount of ink moved from the first pressure adjusting chamber 122 to the second pressure adjusting chamber 152 through such ink flows is supplied from the ink tank 2 to the first pressure adjusting chamber 122 through the filter 110 and the first valve chamber 121. Therefore, the inner volume of the first pressure adjusting chamber 122 is kept constant. From the relationship of Formula 2 described above, if the inner volume of the first pressure adjusting chamber 122 is constant, the spring force F1 of the valve spring 200, the spring force F2 of the pressure adjustment spring 220, the pressure receiving area S1 of the valve 190, and the pressure receiving area S2 of the pressing plate 210 are kept constant. Therefore, the pressure in the first pressure adjusting chamber 122 is determined according to the change in the pressure (gauge pressure) P1 in the first valve chamber 121. Therefore, if there is no change in the pressure P1 in the first valve chamber 121, the pressure P2 in the first pressure adjusting chamber 122 is maintained at the same pressure as the control pressure during the print operation.

On the other hand, the pressure in the second pressure adjusting chamber 152 changes over time in accordance with changes in the inner volume due to the inflow of ink from the first pressure adjusting chamber 122. Specifically, the pressure in the second pressure adjusting chamber 152 changes according to Formula 2 from the state shown in FIG. 10B until the communication port 191 is closed and the second valve chamber 151 and the second pressure adjusting chamber 152 are set in a non-communication state, as shown in FIG. 10C. Thereafter, the pressing plate 210 and the valve shaft 190a are brought into a noncontact state, and the communication port 191 is set in the closed state. Then, as shown in FIG. 10D, the ink flows into the second pressure adjusting chamber 152 through the collection passage 140. This ink inflow displaces the pressing plate 210 and the flexible member 230, and the pressure in the second pressure adjusting chamber 152 changes according to Formula 4, that is, rises until the inner volume of the second pressure adjusting chamber 152 reaches its maximum.

In the state shown in FIG. 10C, the ink does not flow from the first pressure adjusting chamber 122 to the second pressure adjusting chamber 152 through the bypass passage 160 and the second valve chamber 151. Therefore, after the ink in the first pressure adjusting chamber 122 is supplied to the ejection module 300 through the supply passage 130, the ink only flows to the second pressure adjusting chamber 152 through the collection passage 140. As described above, the ink moves from the first pressure adjusting chamber 122 to the second pressure adjusting chamber 152 according to the pressure difference between the pressure in the first pressure adjusting chamber 122 and the pressure in the second pressure adjusting chamber 152. Therefore, the ink stops moving as the pressure in the second pressure adjusting chamber 152 becomes equal to the pressure in the first pressure adjusting chamber 122.

In a state where the pressure in the second pressure adjusting chamber 152 is equal to the pressure in the first pressure adjusting chamber 122, the second pressure adjusting chamber 152 expands to the state shown in FIG. 10D. If the second pressure adjusting chamber 152 is expanded as shown in FIG. 10D, a reservoir portion capable of storing ink is formed in the second pressure adjusting chamber 152. Although it may vary depending on the shape and size of the passages and the properties of the ink, it takes about 1 to 2 minutes to shift to the state shown in FIG. 10D after the circulation pump 500 is stopped. When the circulation pump 500 is driven from the state shown in FIG. 10D where the ink is stored in the reservoir portion, the ink in the reservoir portion is supplied to the first pressure adjusting chamber 122 by the circulation pump 500. This increases the amount of ink in the first pressure adjusting chamber 122 as shown in FIG. 10E, and the flexible member 230 and the pressing plate 210 are displaced in the expansion direction. Then, as the circulation pump 500 continues to be driven, the internal state of the circulation path changes as shown in FIG. 10A.

The above description has been given with reference to FIG. 10A as an example during the print operation, but the ink circulation may be performed without a print operation as described above. In this case, again, the ink flows as shown in FIGS. 10A to 10E as the circulation pump 500 is driven and stopped.

As described above, the example is used in the present embodiment where the communication port 191B in the second pressure adjusting unit 150 is in the open state if the circulation pump 500 is driven to circulate the ink and is in the closed state as the ink circulation is stopped, the present invention is not limited to this example. The control pressure may be set so that the communication port 191B in the second pressure adjusting unit 150 remains in the closed state even if the circulation pump 500 is driven to circulate the ink. This will be described more specifically below together with a role of the bypass passage 160.

In a case where the negative pressure generated in the circulation path becomes greater than a predetermined value, for example, the bypass passage 160 connecting the first pressure adjusting unit 120 and the second pressure adjusting unit 150 is provided to prevent it from affecting the ejection module 300. The bypass passage 160 is also provided to supply the ink to the pressure chamber 12 from both sides of the supply passage 130 and the collection passage 140.

First, an example will be described in which if the negative pressure becomes greater than a predetermined value, the bypass passage 160 is provided to prevent it from affecting the ejection module 300. For example, ink properties (for example, viscosity) may change due to changes in environmental temperature. As the viscosity of the ink changes, the pressure loss within the circulation path also changes. For example, as the viscosity of the ink decreases, the pressure loss within the circulation path decreases. As a result, the flow rate of the circulation pump 500, which is driven at a constant drive amount, increases, and the flow rate of the ink flowing through the ejection module 300 increases. On the other hand, since the ejection module 300 is maintained at a constant temperature by a temperature adjustment mechanism (not shown), the viscosity of the ink within the ejection module 300 is maintained constant even if the environmental temperature changes. While the viscosity of the ink within the ejection module 300 remains unchanged, the flow rate of the ink flowing through the ejection module 300 increases, and flow resistance increases the negative pressure in the ejection module 300. As the negative pressure in the ejection module 300 thus becomes greater than the predetermined value, the meniscus of the ejection port 13 may be destroyed, drawing outside air into the circulation path, thus preventing normal ejection. Even if the meniscus is not destroyed, the negative pressure in the pressure chamber 12 may become greater than the predetermined value, affecting the ejection.

Therefore, in the present embodiment, the bypass passage 160 is formed within the circulation path. By providing the bypass passage 160, if the negative pressure becomes greater than the predetermined value, the ink also flows through the bypass passage 160. This makes it possible to keep the pressure in the ejection module 300 constant. Therefore, the communication port 191B in the second pressure adjusting unit 150, for example, may be configured to have a control pressure to maintain the closed state even if the circulation pump 500 is being driven. Then, the control pressure in the second pressure adjusting unit may be set so that the communication port 191 in the second pressure adjusting unit 150 is in the open state if the negative pressure becomes greater than the predetermined value. In other words, as long as the meniscus is not broken or a predetermined negative pressure is maintained even if the pump flow rate changes with changes in viscosity due to environmental changes, the communication port 191B may be in the closed state if the circulation pump 500 is driven.

Next, an example will be described in which the bypass passage 160 is provided to supply the ink to the pressure chamber 12 from both sides of the supply passage 130 and the collection passage 140. The pressure fluctuations within the circulation path can also be caused by the ejection operation of the ejection element 15. This is because the ejection operation generates a force that draws the ink into the pressure chamber.

Hereinafter, it will be described that, in a case where high-duty printing is continued, the ink supplied to the pressure chamber 12 is supplied from both sides, the supply passage 130 side and the collection passage 140 side. Note that the definition of the duty may change depending on various conditions, but here the state where one 4 pl ink droplet is printed on a 1200 dpi grid is considered as 100%. The high-duty printing is, for example, printing at 100% duty.

As the high-duty printing continues, the amount of ink flowing from the pressure chamber 12 into the second pressure adjusting chamber 152 through the collection passage 140 decreases. On the other hand, since the circulation pump 500 causes a constant amount of ink to flow out, the balance between the inflow and outflow within the second pressure adjusting chamber 152 is disrupted. This reduces the amount of ink inside the second pressure adjusting chamber 152 and increases the negative pressure in the second pressure adjusting chamber 152, thus contracting the second pressure adjusting chamber 152. Then, as the negative pressure in the second pressure adjusting chamber 152 increases, the amount of ink flowing into the second pressure adjusting chamber 152 through the bypass passage 160 increases, and the outflow and inflow are balanced to stabilize the second pressure adjusting chamber 152. As a result, the negative pressure in the second pressure adjusting chamber 152 continues to increase depending on the duty. As described above, in the configuration in which the communication port 191B is in the closed state if the circulation pump 500 is driven, the communication port 191B shifts to the open state depending on the duty, causing the ink to flow into the second pressure adjusting chamber 152 through the bypass passage 160.

Then, as the printing continues at an even higher duty, the amount of ink flowing from the pressure chamber 12 into the second pressure adjusting chamber 152 through the collection passage 140 decreases. Instead, the amount of ink flowing into the second pressure adjusting chamber 152 from the communication port 191B through the bypass passage 160 increases. As this state further progresses, the amount of ink flowing into the second pressure adjusting chamber 152 from the pressure chamber 12 through the collection passage 140 becomes zero, and all the ink flowing out to the circulation pump 500 turns out to be the ink flowing through the communication port 191B. As this state progresses even further, the ink flows back from the second pressure adjusting chamber 152 to the pressure chamber 12 through the collection passage 140. In this state, the ink flowing out of the second pressure adjusting chamber 152 into the circulation pump 500 and the ink flowing out into the pressure chamber 12 flow into the second pressure adjusting chamber 152 from the communication port 191B through the bypass passage 160. In this case, the pressure chamber 12 is filled with the ink in the supply passage 130 and the ink in the collection passage 140, and the ink is ejected.

This ink backflow that occurs if the printing duty is high is a phenomenon that occurs with the bypass passage 160 provided. The above description is given of the example where the communication port 191B in the second pressure adjusting unit is in the open state in response to the ink backflow. However, the ink backflow may occur in a case where the communication port 191B in the second pressure adjusting unit is in the open state. Even in a configuration in which the second pressure adjusting unit is not provided, the above-mentioned ink backflow can occur if the bypass passage 160 is provided. Note that the bypass passage 160 only needs to communicate at least one of the first passage or the first pressure adjusting unit 120 and the second passage without passing through the pressure chamber 12.

### <Configuration of Ejection Unit>

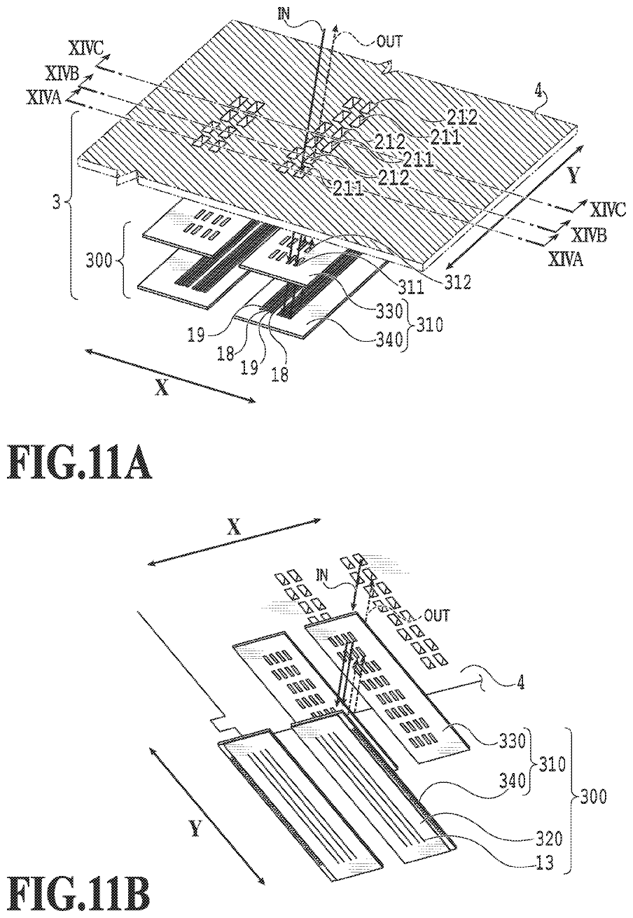

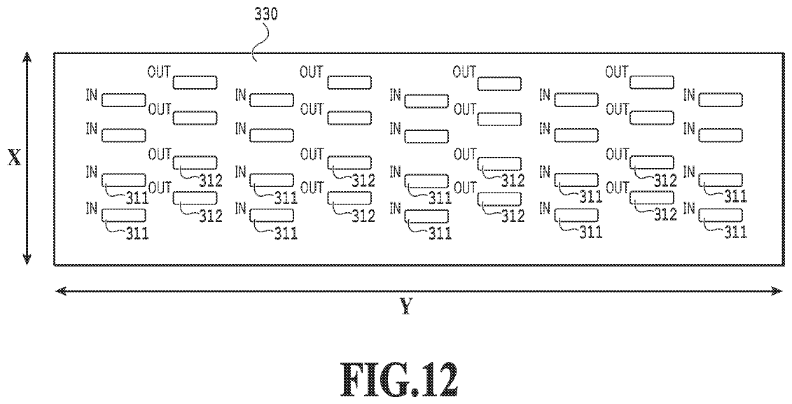

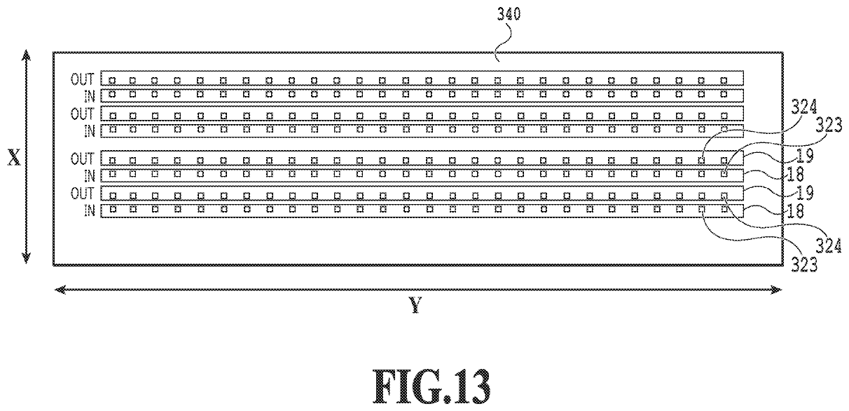

FIGS. 11A and 11B are schematic diagrams showing a circulation path for one color of ink in the ejection unit 3 of the present embodiment. FIG. 11A is an exploded perspective view of the ejection unit 3 seen from the first support member 4 side. FIG. 11B is an exploded perspective view of the ejection unit 3 seen from the ejection module 300 side. Note that the arrows indicated by IN and OUT in FIGS. 11A and 11B indicate ink flows. The ink flows will be described for only one color, but the same applies to the other colors. The illustration of the second support member 7 and the electric wiring member 5 is omitted in FIGS. 11A and 11B, and also in the following description of the configuration of the ejection unit. The first support member 4 in FIG. 11A is as shown in the cross section taken along line XI-XI in FIG. 3. The ejection module 300 includes an ejection element substrate 340 and an aperture plate 330. FIG. 12 is a diagram showing the aperture plate 330. FIG. 13 is a diagram showing the ejection element substrate 340.

The ink is supplied to the ejection unit 3 from the circulation unit 54 through the joint member 8 (see FIG. 3A). The path of the ink after it passes through the joint member 8 until it returns to the joint member 8 will be described. The following drawings omit the illustration of the joint member 8.

The ejection module 300 includes the ejection element substrate 340, which is the silicon substrate 310, and the aperture plate 330, and further includes the ejection port forming member 320. The ejection element substrate 340, the aperture plate 330, and the ejection port forming member 320 are stacked and joined so that the ink passages are communicated with each other, thereby forming the ejection module 300, which is supported by the first support member 4. The ejection unit 3 is formed by the ejection module 300 being supported by the first support member 4. The ejection element substrate 340 includes the ejection port forming member 320, and the ejection port forming member 320 includes a plurality of ejection port arrays in which a plurality of ejection ports 13 are arranged in a row. Some of the ink supplied through the ink passages in the ejection module 300 is ejected from the ejection ports 13. The ink that was not ejected is collected through the ink passage in the ejection module 300.

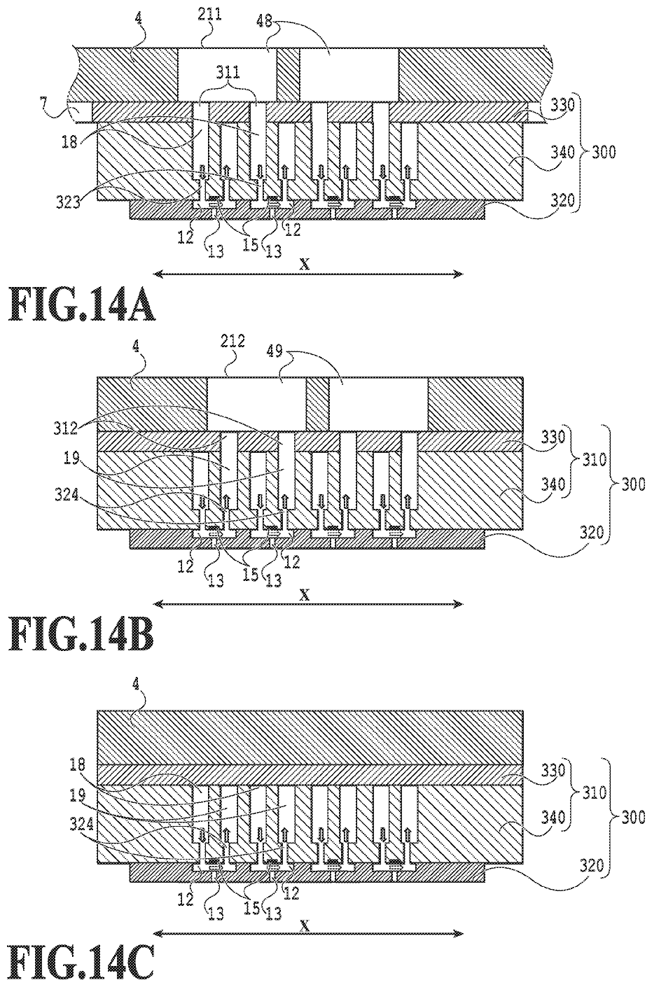

As shown in FIGS. 11 and 12, the aperture plate 330 includes a plurality of arranged ink supply ports 311 and a plurality of arranged ink collection ports 312. As shown in FIGS. 13 and 14A to 14C, the ejection element substrate 340 includes a plurality of arranged supply connection flow paths 323 and a plurality of arranged collection connection flow paths 324. The ejection element substrate 340 further includes the common supply passage 18 communicated with the plurality of supply connection flow paths 323 and the common collection passage 19 communicated with the plurality of collection connection flow paths 324. The ink passage in the ejection unit 3 is formed by communicating the ink supply passage 48 and ink collection passage 49 provided in the first support member 4 (see FIG. 3) with the passage provided in the ejection module 300. A support member supply port 211 is a cross-section opening that forms the ink supply passage 48, and the support member collection port 212 is a cross-section opening that forms the ink collection passage 49.

The ink supplied to the ejection unit 3 is supplied from the circulation unit 54 side (see FIG. 3A) to the ink supply passage 48 of the first support member 4 (see FIG. 3A). The ink flowing through the support member supply port 211 in the ink supply passage 48 is supplied to the common supply passage 18 of the ejection element substrate 340 through the ink supply passage 48 (see FIG. 3A) and the ink supply port 311 of the aperture plate 330 and enters the supply connection flow path 323. The passage up to this point serves as the supply side passage. Thereafter, the ink flows to the collection connection flow path 324 of the collection side passage through the pressure chamber 12 of the ejection port forming member 320 (see FIG. 3B). The ink flow in the pressure chamber 12 will be described in detail later.

In the collection side passage, the ink entering the collection connection flow path 324 flows into the common collection passage 19. The ink then flows from the common collection passage 19 to the ink collection passage 49 of the first support member 4 through the ink collection port 312 of the aperture plate 330 and is collected by the circulation unit 54 through the support member collection port 212.

The area in the aperture plate 330 where the ink supply port 311 and the ink collection port 312 are not provided corresponds to the area for partitioning the support member supply port 211 and the support member collection port 212 in the first support member 4. The first support member 4 also has no opening in this area. Such an area is used as a bonding area in a case of bonding the ejection module 300 and the first support member 4.

In FIG. 12, the aperture plate 330 has a plurality of rows of openings arranged in the X direction are provided in the Y direction, and supply (IN) openings and collection (OUT) openings are alternately arranged in the Y direction so as to be shifted by a half pitch in the X direction. In FIG. 13, the common supply passage 18 communicated with the plurality of supply connection flow paths 323 arranged in the Y direction and the common collection passage 19 communicated with the plurality of collection connection flow paths 324 arranged in the Y direction are alternately arranged in the X direction in the ejection element substrate 340. The common supply passage 18 and the common collection passage 19 are separated for each type of ink, and the number of the common supply passages 18 and common collection passages 19 to be arranged is determined according to the number of ejection port arrays for each color. Furthermore, the supply connection flow paths 323 and the collection connection flow paths 324 are also arranged corresponding to the number of the ejection ports 13. Note that one-to-one correspondence is not necessarily required, and one supply connection flow path 323 and one collection connection flow path 324 may correspond to a plurality of ejection ports 13.

The aperture plate 330 as described above and the ejection element substrate 340 are stacked and joined together so that the ink passages are communicated with each other, thereby forming the ejection module 300, which is supported by the first support member 4 to form the ink passage including the supply passage and the collection passage as described above.

FIGS. 14A to 14C are cross-sectional views showing an ink flow in a different part of the ejection unit 3. FIG. 14A is a cross-sectional view taken along line XIVa-XIVa in FIG. 11A, showing a cross section of a portion of the ejection unit 3 where the ink supply passage 48 and the ink supply port 311 are communicated with each other. FIG. 14B is a cross-sectional view taken along line XIVb-XIVb in FIG. 11A, showing a cross section of a portion of the ejection unit 3 where the ink collection passage 49 and the ink collection port 312 are communicated with each other. FIG. 14C is a cross-sectional view taken along line XIVc-XIVc in FIG. 11A, showing a cross section of a portion where the ink supply port 311 and the ink collection port 312 are not communicated with the passage in the first support member 4.

In the supply passage for supplying ink, the ink is supplied from a portion where the ink supply passage 48 of the first support member 4 and the ink supply port 311 of the aperture plate 330 overlap and are communicated with each other, as shown in FIG. 14A. In the collection passage for collecting ink, the ink is collected from a portion where the ink collection passage 49 of the first support member 4 and the ink collection port 312 of the aperture plate 330 overlap and are communicated with each other, as shown in FIG. 14B. As shown in FIG. 14C, in the ejection unit 3, openings are not provided in some areas of the aperture plate 330. In such an area, no ink is supplied or collected between the ejection element substrate 340 and the first support member 4. The ink is supplied in the area where the ink supply port 311 is provided as shown in FIG. 14A, and is collected in the area where the ink collection port 312 is provided as shown in FIG. 14B. Although the description is given of the configuration using the aperture plate 330 as an example in the present embodiment, a configuration may be adopted which does not use the aperture plate 330. For example, a configuration may be adopted in which passages corresponding to the ink supply passage 48 and the ink collection passage 49 are formed in the first support member 4, and the ejection element substrate 340 is bonded to the first support member 4.

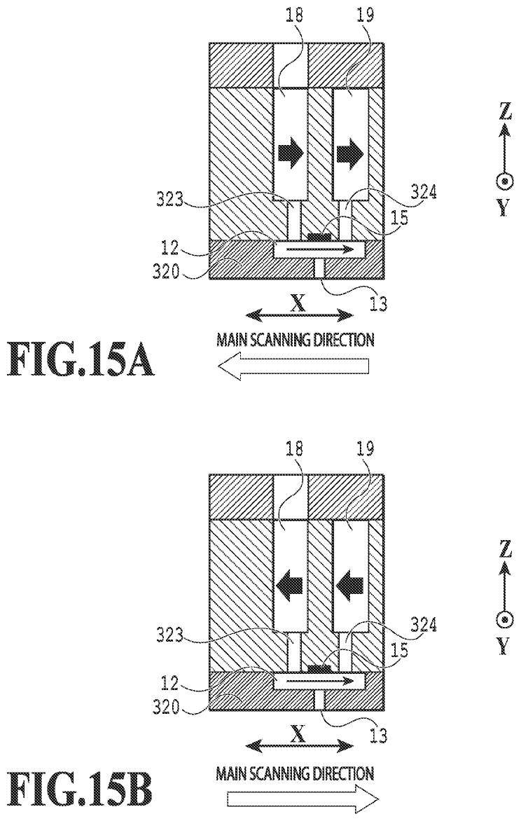

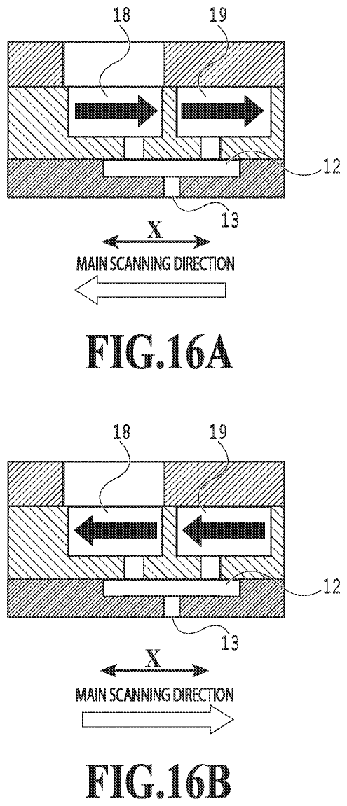

FIGS. 15A and 15B are cross-sectional views showing the vicinity of the ejection port 13 in the ejection module 300. FIG. 16 is a cross-sectional view showing an ejection module having a configuration in which the common supply passage 18 and the common collection passage 19 are expanded in the X direction as a comparative example. Note that the thick arrows shown in the common supply passage 18 and the common collection passage 19 in FIGS. 15A and 15B and FIGS. 16A and 16B indicate ink oscillation in a configuration using the serial type liquid ejection apparatus 50. The ink supplied to the pressure chamber 12 through the common supply passage 18 and the supply connection flow path 323 is ejected from the ejection port 13 by driving the ejection element 15. If the ejection element 15 is not driven, the ink is collected from the pressure chamber 12 to the common collection passage 19 through the collection connection flow path 324 as the collection passage.

In a case of ejecting the circulating ink as described above in the configuration using the serial type liquid ejection apparatus 50, the ink ejection is affected in no small part by the ink oscillation within the ink passage due to the main scanning of the liquid ejection head 1. Specifically, the influence of the ink oscillation within the ink passage may appear as a difference in the ink ejection amount or a shift in the ejection direction. As shown in FIG. 16, if the common supply passage 18 and the common collection passage 19 have a wide cross-sectional shape in the X direction, which is the main scanning direction, the ink in the common supply passage 18 and the common collection passage 19 easily receives inertial force in the main scanning direction, causing large ink oscillation. This ink oscillation may affect the ink ejection from the ejection ports 13. If the common supply passage 18 and the common collection passage 19 are expanded in the X direction, the distance between colors increases, leading to possible degradation in printing efficiency.

Therefore, the common supply passage 18 and the common collection passage 19 according to the present embodiment are configured to both extend not only in the Y direction but also in the Z direction perpendicular to the X direction, which is the main scanning direction, in the cross section shown in FIGS. 15A and 15B. With such a configuration, the width of each of the common supply passage 18 and the common collection passage 19 in the main scanning direction can be reduced. Such a reduction in the width of the common supply passage 18 and the common collection passage 19 in the main scanning direction reduces the ink oscillation due to the inertial force (thick black arrows in FIGS. 15A and 15B) opposite to the main scanning direction that acts on the ink in the common supply passage 18 and the common collection passage 19 during main scanning. This makes it possible to suppress the influence of ink oscillation on ink ejection. By extending the common supply passage 18 and the common collection passage 19 in the Z direction, the cross-sectional area is increased to reduce passage pressure loss.

As described above, by reducing the width of each of the common supply passage 18 and the common collection passage 19 in the main scanning direction, the ink oscillation can be reduced in the common supply passage 18 and the common collection passage 19 during main scanning. However, this does not mean that the oscillation is eliminated. Therefore, to suppress the difference in ejection for each type of ink that may still occur even if the oscillation is reduced, the common supply passage 18 and the common collection passage 19 are arranged at overlapping positions in the X direction in the present embodiment.

As described above, in the present embodiment, the supply connection flow path 323 and the collection connection flow path 324 are provided corresponding to the ejection port 13. The correspondence relationship between the supply connection flow path 323 and the collection connection flow path 324 is such that they are arranged side by side in the X direction with the ejection port 13 interposed therebetween. Therefore, there is a portion where the common supply passage 18 and the common collection passage 19 do not overlap in the X direction. If the correspondence between the supply connection flow path 323 and the collection connection flow path 324 in the X direction collapses, this affects the flow and ejection of ink in the X direction in the pressure chamber 12. The influence of ink oscillation added thereto may further affect the ink ejection from each ejection port.

Therefore, by arranging the common supply passage 18 and the common collection passage 19 at overlapping positions in the X direction, the common supply passage 18 and the common collection passage 19 have substantially the same ink oscillation during the main scanning at any position in the Y direction in which the ejection ports 13 are arranged. This prevents a large variation in the pressure difference between the common supply passage 18 side and the common collection passage 19 side that occurs inside the pressure chamber 12, making it possible to perform stable ejection.

In some liquid ejection heads that circulate ink, the passage for supplying ink to the liquid ejection head and the passage for collecting ink are configured as the same passage. In the present embodiment, on the other hand, the common supply passage 18 and the common collection passage 19 are separate passages. The supply connection flow path 323 and the pressure chamber 12 are communicated with each other, and the pressure chamber 12 and the collection connection flow path 324 are communicated with each other, so that ink is ejected from the ejection port 13 of the pressure chamber 12. In other words, the pressure chamber 12, which is the path connecting the supply connection flow path 323 and the collection connection flow path 324, is configured to include the ejection port 13. Therefore, an ink flow is generated in the pressure chamber 12 from the supply connection flow path 323 side to the collection connection flow path 324 side, and the ink in the pressure chamber 12 is efficiently circulated. By efficiently circulating the ink in the pressure chamber 12, the ink in the pressure chamber 12, which is easily affected by evaporation of ink from the ejection port 13, can be kept fresh.

Since the two passages, the common supply passage 18 and the common collection passage 19, are communicated with the pressure chamber 12, the ink can be supplied from both passages if ejection at a high flow rate is necessary. Specifically, compared to a configuration in which only one passage is used to perform ink supply and collection, the configuration according to the present embodiment has an advantage of not only allowing efficient circulation but also supporting high flow rate ejection.

The common supply passage 18 and the common collection passage 19 are less likely to be affected by ink oscillation if they are arranged closer to each other in the X direction. The distance between the passages is preferably 75 m to 100 m.

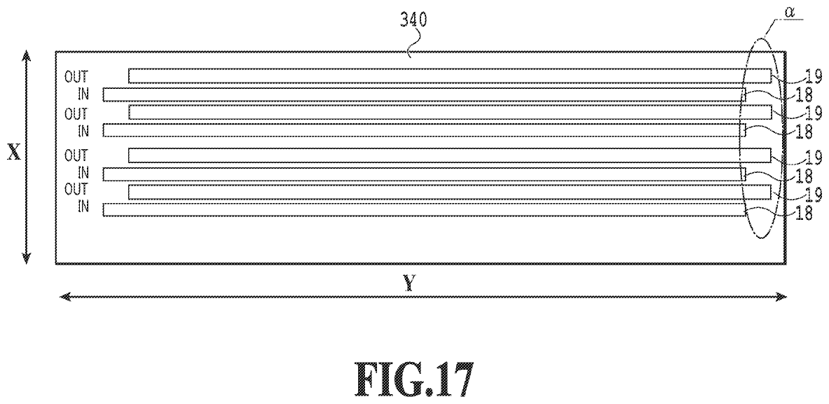

FIG. 17 is a diagram showing an ejection element substrate 340 as a comparative example. FIG. 17 omits the illustration of the supply connection flow path 323 and the collection connection flow path 324. Since ink that has received thermal energy from the ejection element 15 in the pressure chamber 12 flows into the common collection passage 19, ink having a temperature relatively higher than that of the ink in the common supply passage 18 flows. In this event, in the comparative example, there is a portion where only the common collection passage 19 exists in a portion of the ejection element substrate 340 in the X direction, such as a portion a surrounded by the dashed line in FIG. 17. In this case, the temperature locally increases in that portion, causing temperature variation within the ejection module 300, which may affect ejection.

Ink having a temperature relatively lower than that of the ink in the common collection passage 19 flows through the common supply passage 18. Therefore, if the common supply passage 18 and the common collection passage 19 are adjacent to each other, the temperatures in the common supply passage 18 and the common collection passage 19 are partially canceled out in the vicinity thereof, thus suppressing a rise in temperature. Therefore, it is preferable that the common supply passage 18 and the common collection passage 19 have substantially the same length, are located at positions overlapping each other in the X direction, and are adjacent to each other.

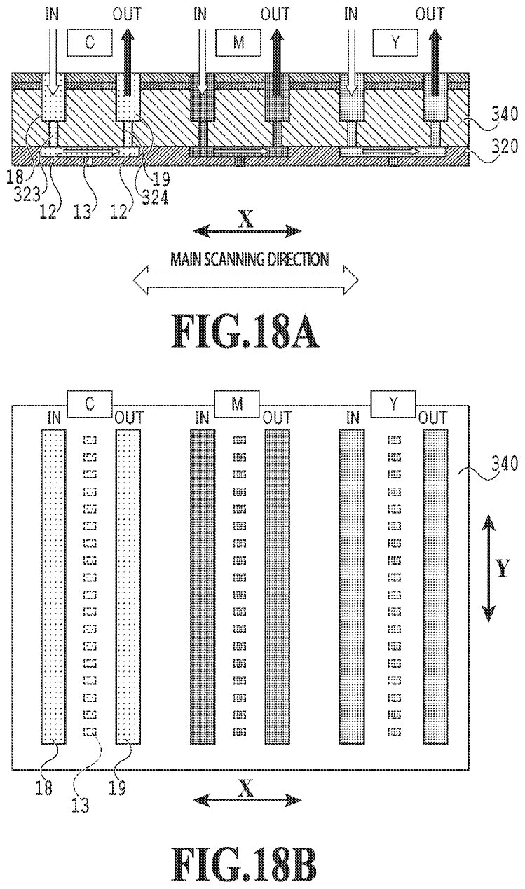

FIGS. 18A and 18B are diagrams showing the passage configuration of the liquid ejection head 1 that supports three colors of inks: cyan (C), magenta (M), and yellow (Y). The liquid ejection head 1 is provided with circulation passages for each type of ink, as shown in FIG. 18A. The pressure chamber 12 is provided along the X direction, which is the main scanning direction of the liquid ejection head 1. As shown in FIG. 18B, the common supply passage 18 and the common collection passage 19 are provided along the ejection port array in which the ejection ports 13 are arranged. The common supply passage 18 and the common collection passage 19 and are provided extending in the Y direction so as to sandwich the ejection port array.

### <Connection Between Main Body and Liquid Ejection Head>

FIG. 19 is a schematic configuration diagram showing in more detail the connection state between the liquid ejection head 1 and the ink tank 2 and the external pump 21 provided in the main body of the liquid ejection apparatus 50 of the present embodiment, and the arrangement of the circulation pump and the like. The liquid ejection apparatus 50 according to the present embodiment has a configuration that allows only the liquid ejection head 1 to be easily replaced in case of failure in the liquid ejection head 1. Specifically, the liquid ejection apparatus 50 includes a liquid connection unit 700 that allows the ink supply tube 59 connected to the external pump 21 and the liquid ejection head 1 to be easily connected and disconnected. This makes it possible to easily attach and detach only the liquid ejection head 1 to and from the liquid ejection apparatus 50.

As shown in FIG. 19, the liquid connection unit 700 includes the liquid connector insertion slot 53a protruding from the head housing 53 of the liquid ejection head 1, and a cylindrical liquid connector 59a into which the liquid connector insertion slot 53a can be inserted. The liquid connector insertion slot 53a is fluidly connected to the ink supply passage formed in the liquid ejection head 1, and is connected to the first pressure adjusting unit 120 through the filter 110 described above. The liquid connector 59a is provided at the tip of the ink supply tube 59 connected to the external pump 21 that supplies ink from the ink tank 2 to the liquid ejection head 1 under pressure.

As described above, in the liquid ejection head 1 shown in FIG. 19, the liquid connection unit 700 allows the liquid ejection head 1 to be easily attached and detached or replaced. However, if the sealing property deteriorates between the liquid connector insertion slot 53a and the liquid connector 59a, there is a possibility that the ink supplied under pressure by the external pump 21 may leak from the liquid connection unit 700. If the leaked ink adheres to the circulation pump 500 or the like, failure may occur in the electric system. Therefore, in the present embodiment, the circulation pump and the like are arranged as follows.

<Arrangement of Circulation Pump and the like>

As shown in FIG. 19, in the present embodiment, the circulation pump 500 is arranged above the liquid connection unit 700 in the direction of gravity, in order to prevent the ink leaked from the liquid connection unit 700 from adhering to the circulation pump 500. That is, the circulation pump 500 is arranged above the liquid connector insertion slot 53a, which is the liquid inlet of the liquid ejection head 1, in the direction of gravity. The circulation pump 500 is arranged at a position where it does not come into contact with the members included in the liquid connection unit 700. This can prevent the ink from reaching the circulation pump 500 located above in the direction of gravity, since the ink flows in the horizontal direction that is the opening direction of the liquid connector 59a or flows downward in the direction of gravity even if the ink leaks from the liquid connection unit 700. Since the circulation pump 500 is disposed at a position away from the liquid connection unit 700, the possibility of ink reaching the circulation pump 500 through the members is also reduced.

An electrical connection unit 515 that electrically connects the circulation pump 500 and the electric contact substrate 6 through a flexible wiring member 514 is provided above the liquid connection unit 700 in the direction of gravity. This can reduce the possibility of electrical trouble caused by ink from the liquid connection unit 700.

In the present embodiment, since a wall portion 52b of the head housing 53 is provided, even if ink is ejected from the opening 59b of the liquid connection unit 700, the wall portion can block the ink, thus reducing the possibility of ink reaching the circulation pump 500 and the electrical connection unit 515.

### <Ink Backflow Around Ejection Port>

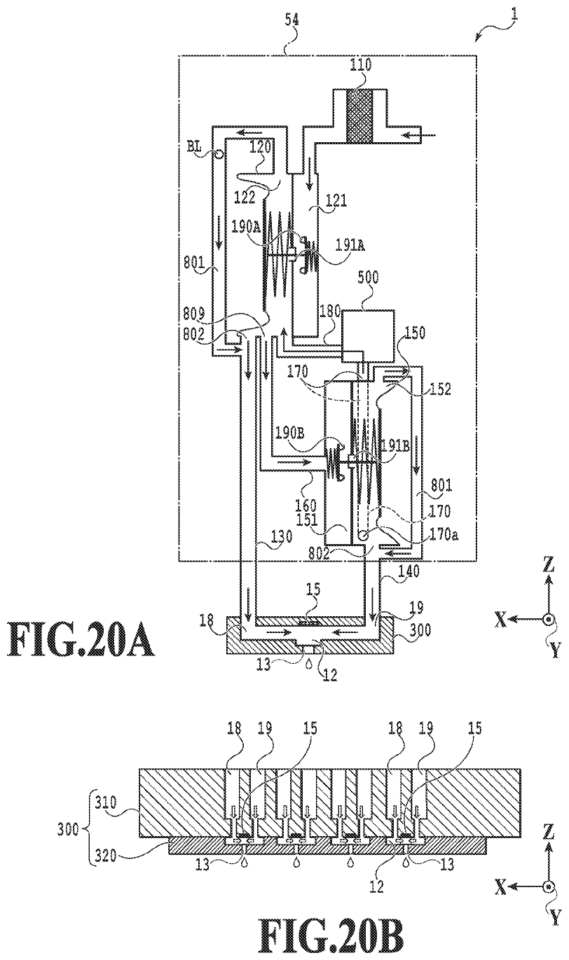

Next, the features of the present invention will be described below. FIGS. 20A and 20B are diagrams schematically showing ink backflow around the ejection port. FIG. 20A is a diagram schematically showing the circulation path shown in FIG. 5. FIG. 20B is an enlarged view of the ejection module shown in FIG. 3B. In FIGS. 5 and 3B, the ink in the pressure chamber 12 flows in from the common supply passage 18, passes through the pressure chamber 12, and flows out from the common collection passage 19. As described above, in a case where high-duty printing is continued, the ink also flows back into the pressure chamber 12 from the collection passage 140 side. That is, as shown in FIG. 20, the pressure chamber 12 is refilled with ink from both the supply passage 130 (common supply passage 18) and the collection passage 140 (common collection passage 19). Specifically, the ink supplied from the first pressure adjusting chamber 122 to the bypass passage 160 is supplied to the second pressure adjusting chamber 152 through the second valve chamber 151 of the second pressure adjusting unit 150. Some of the ink supplied to the second pressure adjusting chamber 152 is then supplied to the collection passage 140 and to the ejection port 13 through the common collection passage 19.

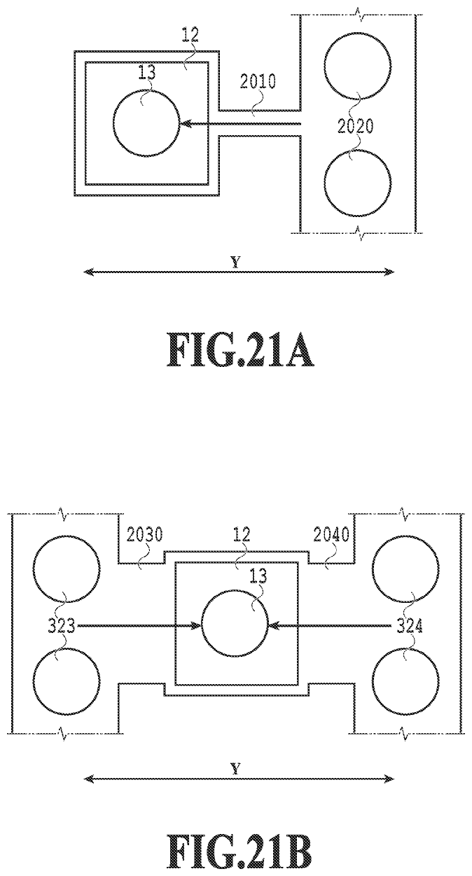

FIGS. 21A and 21B are diagrams illustrating ink supply within the ejection module 300. FIG. 21A is a diagram showing a passage configuration in the vicinity of the pressure chamber 12 according to a comparative example different from the present embodiment. In FIG. 21A, only one of the pressure chambers 12 is communicated with a passage 2010. In this configuration, the ink supply to the pressure chamber 12 is one-side supply through the passage 2010 only. In the configuration of FIG. 21A, an independent supply port 2020 communicated with the pressure chamber 12 is connected to the common supply passage 18 and/or the common collection passage 19. In the case of using a thermal type ejection element, in particular, as the ejection element 15, ink is ejected from the ejection port 13 by foaming inside the pressure chamber 12. The pressure chamber 12 is refilled with ink by defoaming in response to the foaming. In such a passage configuration, rear resistance during foaming is increased by reducing the width or increasing the length of the passage 2010 connected to the pressure chamber 12. This makes the foaming more symmetrical and improves droplet formation. On the other hand, in the configuration as shown in FIG. 21A, the rear resistance increases, resulting in deterioration in supply performance during refilling of ink in the pressure chamber 12 at the time of defoaming after ejection. Therefore, with the passage configuration shown in FIG. 21A, it is generally difficult to improve the refill frequency. In a case of performing a print operation at a high duty, in particular, the amount of ink supplied to the ejection ports may decrease, resulting in reduction in ejection stability.

On the other hand, FIG. 21B is a diagram showing the passage configuration in the vicinity of the pressure chamber 12 in the present embodiment. The supply connection flow path 323, which is a first independent supply port, connects a first liquid passage 2030 leading to the pressure chamber 12 and the common supply passage 18. The collection connection flow path 324, which is a second independent supply port, connects a second liquid passage 2040 leading to the pressure chamber 12 and the common collection passage 19. As described above, in the present embodiment, the ink ejected from the ejection port 13 is refilled through the first liquid passage 2030 and the second liquid passage 2040. As shown in FIG. 21B, a both-side supply configuration is adopted, in which both sides of the pressure chamber 12 are communicated with the first liquid passage 2030 and the second liquid passage 2040. In such a configuration, as shown in FIG. 21B, even if the width or length of the passage leading to the pressure chamber 12 is increased or reduced, the symmetry of the rear resistance during foaming makes it easier for the foaming to become symmetrical. Therefore, the formation of ink droplets is improved. There is also no need to increase the rear resistance in a case of refilling the pressure chamber 12 with ink during defoaming after ejection. The ink supply performance can thus be improved. As described above, according to the present embodiment, the ejection stability can be improved also in the case of performing a print operation at a high duty. That is, it is possible to achieve both improvement in droplet formation and improvement in refill frequency.

Although the above-described embodiment mainly uses a thermal type ejection element, a piezo type ejection element may also be used. However, it is more difficult with the thermal type to achieve both improvement in droplet formation and improvement in refill frequency. The present embodiment is thus more suitable for the thermal type.

### <Discharge of Bubbles Inside Head>

In a circulating-type liquid ejection head as in the present embodiment, the ink storage volume inside the liquid ejection head is easily increased by the ink collection passage, pressure adjustment mechanism, and the like, compared to a non-circulating type liquid ejection head. As the ink storage volume inside the liquid ejection head increases, the amount of remaining air bubbles generally tends to increase as the liquid ejection head is filled with ink. If there is a large amount of bubbles remaining after filling, the amount of bubbles that enter the inside of the liquid ejection head through gas permeation from outside the liquid ejection head tends to increase as time passes. Furthermore, in a case where a temperature adjustment mechanism is provided as in the present embodiment, as the temperature of the ink rises due to the temperature adjustment mechanism, air bubbles dissolved in the ink tend to precipitate, resulting in a possibility of further increasing the amount of air bubbles in the liquid ejection head.

If bubbles remaining in the liquid ejection head flow into the pressure chamber, sufficient pressure for ejection cannot be transmitted to the liquid inside the pressure chamber during ejection, which may cause ejection failure. Furthermore, in the present embodiment, a piezoelectric pump is provided as the circulation pump in the liquid ejection head. In a case of using the piezoelectric pump, the pressure in the pump chamber changes during a pump operation if residual bubbles in the liquid ejection head flow into the piezoelectric pump. This pressure change may change the flow rate, and a change in the circulating flow rate may cause ejection failure. Therefore, it is important to efficiently remove air bubbles inside the liquid ejection head.

First, with reference to FIG. 20, a description is given of the ink flow and operations of the first pressure adjusting unit 120 and the second pressure adjusting unit 150 in a case of discharging air bubbles inside the liquid ejection head 1 according to the present embodiment. Bubbles BL entering the first pressure adjusting chamber 122 and second pressure adjusting chamber 152 through gas permeation from the upstream side of the first pressure adjusting unit 120, inside the circulation path, or from the outside of the liquid ejection head 1 tend to stay in the upper part of each of the first pressure adjusting chamber 122 and the second pressure adjusting chamber 152. The bubbles BL collected in the upper part of the first pressure adjusting chamber 122 and the second pressure adjusting chamber 152 can be discharged together with the ink through suction process for forcibly sucking the ink from the ejection port in a state where no liquid ejection operation is performed.

The suction process is performed by bringing a cap member into close contact with the ejection port surface of the liquid ejection head 1 where the ejection ports are formed, and applying a negative pressure from a negative pressure source connected to the cap member to the ejection ports, thereby forcibly sucking the ink. The ink flow velocity within the passage during this suction is faster than the ink flow velocity during a normal ink ejection operation. Therefore, the bubbles BL collected in the upper part of the first pressure adjusting chamber 122 and the second pressure adjusting chamber 152 reach the pressure chamber 12 through the supply passage 130 or the collection passage 140 together with the ink, and then are discharged through the ejection ports 13 together with the ink. Note that this suction process is generally executed during a suction recovery process for recovering the ejection performance by discharging thickened ink or the like in the ejection port, the pressure chamber, or the like from the ejection port, or during initial filling process for filling the passages with ink.

Hereinafter, the circulation path configured inside the liquid ejection head 1 according to the present embodiment will be described in detail.

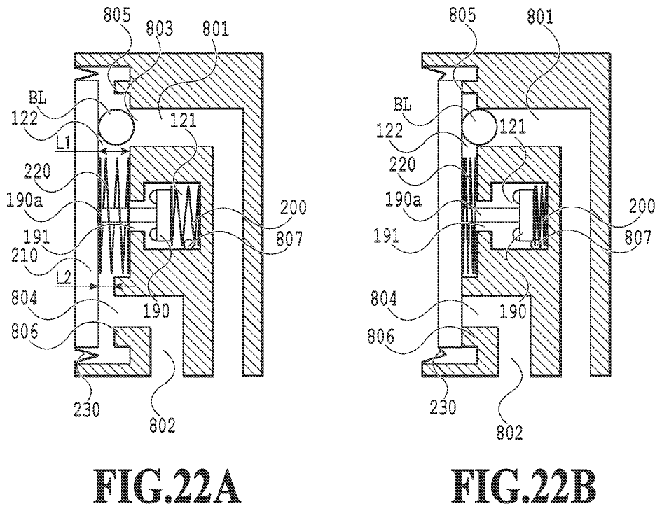

FIGS. 22A and 22B are diagrams schematically showing the passage configuration in the liquid ejection head 1 according to the present embodiment. FIGS. 22A and 22B show a state closer to the embodiment than FIGS. 20A and 20B. The first discharge passage 801 and the second discharge passage 802 are connected to the first pressure adjusting chamber 122, respectively, and also connected to the supply passage 130. A valve chamber supply port 807 is an ink supply port from the liquid ejection apparatus 50 to the first valve chamber 121. A first outlet 803 is formed at the connection between the first discharge passage 801 and the first pressure adjusting chamber 122. A second outlet 804 is formed at the connection between the second discharge passage 802 and the first pressure adjusting chamber 122.

As described above, the bubbles BL accumulated in the first pressure adjusting chamber 122 are collected after floating to the upper part of the first pressure adjusting chamber 122. Therefore, the first outlet 803 is preferably disposed in the upper part of the first pressure adjusting chamber 122, and more preferably connected to the upper end thereof. The second outlet 804, on the other hand, is preferably disposed at the bottom so that the bubbles BL in the first pressure adjusting chamber 122 are hardly discharged.

Next, displacement of the pressing plate 210 according to the present embodiment will be described. As shown in Formula 2 above, the flexible member 230 and the pressing plate 210 are displaced to the right in FIGS. 22A and 22B, in response to the pressure in the first pressure adjusting chamber 122, and the pressing plate 210 comes into contact with the valve shaft 190a to set the communication port 191 is in the open state. Even after the communication port 191 is set in the open state, the pressing plate 210 is displaced according to Formula 2. Considering the pressure loss in the flow of ink flowing from the first valve chamber 121 through the communication port 191 to the first pressure adjusting chamber 122, the faster the ink flow velocity, the greater the pressure loss. Therefore, the pressure loss in the flow from the first valve chamber 121 to the first pressure adjusting chamber 122 is expressed as a pressure difference P1-P2 between the pressure P1 in the first valve chamber 121 and the pressure P2 in the first pressure adjusting chamber 122. Therefore, the pressure P2 decreases as the ink flow velocity increases for a certain pressure P1.

On the other hand, the pressure P1 indicates the pressure of ink that is pressurized by the external pump 21 and supplied to the first valve chamber 121 through the filter 110 from the liquid ejection apparatus 50. Therefore, in a case of the same pump capacity, as the ink flow velocity increases, the pressure P1 decreases due to pressure loss through the ink passage from the external pump 21 to the first valve chamber 121 and the filter 110. Therefore, the pressure P1 decreases as the ink flow velocity increases. The pressure P2 decreases as the pressure loss increases in the flow of ink flowing from the first valve chamber 121 through the communication port 191 to the first pressure adjusting chamber 122.

As described above, the pressing plate 210 is displaced according to the pressure P2 in the first pressure adjusting chamber 122, as shown in FIGS. 7A to 7C. Therefore, as the ink flow velocity increases, the pressure P2 in the first pressure adjusting chamber 122 decreases. The pressing plate 210 and the flexible member 230 are displaced in the direction in which the inner volume of the first pressure adjusting chamber 122 decreases, that is, to the right in FIGS. 22A and 22B against the biasing force of the pressure adjustment spring 220 and the valve spring 200.

Next, a description is given of the ink flow velocity in the first discharge passage 801 and the second discharge passage 802 in a state where the liquid ejection operation is performed and in a state where the suction process is performed according to the present embodiment. FIG. 22A schematically shows the state where the liquid ejection operation is performed. FIG. 22B schematically shows the state where the suction process is performed. In both the state where the liquid ejection operation is performed and the state where the suction process is performed, the flow velocity of the ink flowing into the first pressure adjusting chamber 122 is faster in the state where the suction process is performed.

As shown in FIG. 22A, the pressing plate 210 is configured to be spaced apart from a second stopper 805 and a first stopper 806 in the state where the liquid ejection operation is performed. In other words, the pressing plate 210 at the pressure P2 determined by the flow velocity of the ink flowing into the first pressure adjusting chamber 122 is separated from the second stopper 805 and the first stopper 806 by adjusting the biasing force of the pressure adjustment spring 220 and the valve spring 200 and the pressure receiving area of the pressing plate 210. In this state, the first discharge passage 801 and the second discharge passage 802 are both communicated with the first pressure adjusting chamber 122. Then, the ink is ejected through a passage from the first pressure adjusting chamber 122 to the supply passage 130 through the first discharge passage 801 and a passage from the first pressure adjusting chamber 122 to the supply passage 130 through the second discharge passage 802 according to the ratio of flow resistance therebetween.

In this state, the bubbles BL accumulated in the upper part of the first pressure adjusting chamber 122 are hardly discharged to the ejection module 300 through the first discharge passage 801 and the supply passage 130. Therefore, the resistance of the passage from the first pressure adjusting chamber 122 through the first discharge passage 801 to the supply passage 130 is preferably set as large as possible, or the resistance of the passage from the first pressure adjusting chamber 122 through the second discharge passage 802 to the supply passage 130 is preferably set to be small.

In the state where the suction operation is performed, on the other hand, the pressing plate 210 is configured to come into contact with the second stopper 805 and the first stopper 806. That is, the pressing plate 210 at the pressure P2 determined by the flow velocity of the ink flowing into the first pressure adjusting chamber 122 comes into contact with the second stopper 805 and the first stopper 806 by adjusting the biasing force of the pressure adjustment spring 220 and the valve spring 200 and the pressure receiving area of the pressing plate 210.

In this state, the first discharge passage 801 is communicated with the first pressure adjusting chamber 122, and the second discharge passage 802 is not communicated with the first pressure adjusting chamber 122. The ink is thus discharged from the first pressure adjusting chamber 122 through the first discharge passage 801 to the supply passage 130. Therefore, during the suction process, the flow velocity of ink discharged from the first pressure adjusting chamber 122 through the first discharge passage 801 increases. The bubbles BL accumulated in the first pressure adjusting chamber 122 thus pass through the first discharge passage 801 and are finally discharged to the outside of the liquid ejection head 1 from the ejection port through the supply passage 130.

The description has been given of the case where the second discharge passage 802 is not communicated with the first pressure adjusting chamber 122 in the state where the suction operation is performed, as a desirable example, but the present invention is not limited to this example. The ratio of flow resistance between the passage from the first pressure adjusting chamber 122 to the supply passage 130 through the first discharge passage 801 and the passage from the first pressure adjusting chamber 122 to the supply passage 130 through the second discharge passage 802 is set larger during the suction operation than during the liquid ejection operation. Such a configuration (including flow resistance increasing means for increasing the flow resistance) can also achieve certain effects.

With respect to the flow velocity of ink flowing from the first pressure adjusting chamber 122 to the supply passage 130 through the second discharge passage 802, the ink flow velocity from the first pressure adjusting chamber 122 to the supply passage 130 through the first discharge passage 801 is set faster during the suction operation than during the liquid ejection operation. Such a configuration can also achieve certain effects.

For example, as shown in FIGS. 22A and 22B, L1>L2 where L1 is the distance between the pressing plate 210 and the first outlet 803 in the displacement direction of the pressing plate 210 and L2 is the distance between the pressing plate 210 and the second outlet 804 in the displacement direction of the pressing plate 210. Therefore, a rate of change in flow resistance in this portion relative to the amount of displacement, as the pressing plate 210 is displaced from the state where the liquid ejection operation is performed to the state where the suction operation is performed, is greater at the second outlet. As a result, the flow resistance of the passage from the first pressure adjusting chamber 122 to the supply passage 130 through the second discharge passage 802, with respect to the flow resistance of the passage from the first pressure adjusting chamber 122 to the supply passage 130 through the first discharge passage 801, can be set larger during the suction operation than during the liquid ejection operation.

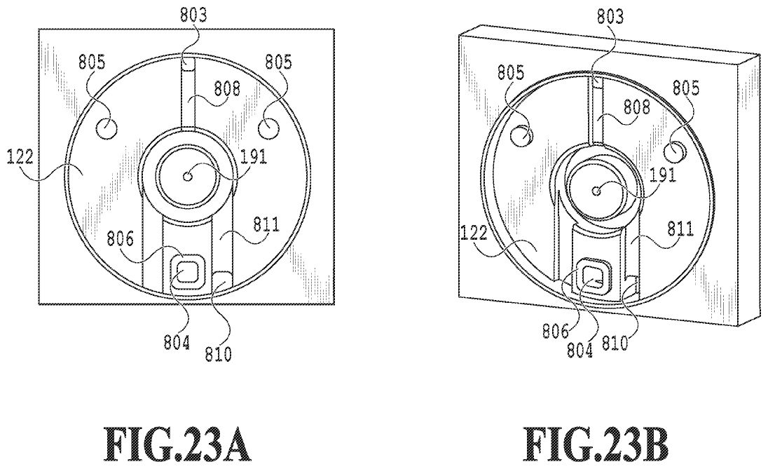

FIGS. 23A and 23B are front sectional views of the first pressure adjusting chamber 122 according to the present embodiment. The second stopper 805, the first stopper 806, and a first slit 808 in the first pressure adjusting chamber 122 according to the present embodiment will be described below with reference to FIGS. 23A and 23B. The second stoppers 805 are provided at two locations in the vertically upper part of the first pressure adjusting chamber 122, and the first stopper 806 is provided so as to surround the second outlet 804. As the pressing plate 210 is displaced in the state where the suction operation is performed, the pressing plate 210 comes into contact with the second stopper 805 and the first stopper 806. Therefore, the inclination of the pressing plate 210 in the displacement direction is restricted at three locations, including the two second stoppers 805 and the first stopper 806. The first stopper 806 and the pressing plate 210 can be maintained in a substantially parallel state. This makes it easier for the entire area of the first stopper 806 to come into contact with the pressing plate 210, and makes it easier for the second discharge passage 802 to be not communicated with the first pressure adjusting chamber 122.

The first slit 808 has a concave shape to facilitate communication between the first pressure adjusting chamber 122 and the first discharge passage 801 in a state where the pressing plate 210 is in contact with the second stopper 805 and the first stopper 806. The first slit 808 is disposed extending from the center of the first pressure adjusting chamber 122 toward the first outlet 803. Therefore, the first pressure adjusting chamber 122 and the first discharge passage 801 can secure a certain amount of passage cross section defined by the first slit 808 also in the state where the pressing plate 210 is in contact with the second stopper 805 and the first stopper 806. This makes it possible to reduce the flow resistance of the ink passage from the first pressure adjusting chamber 122 through the first discharge passage 801, and to suppress a decrease in the ink flow velocity through the first discharge passage 801.

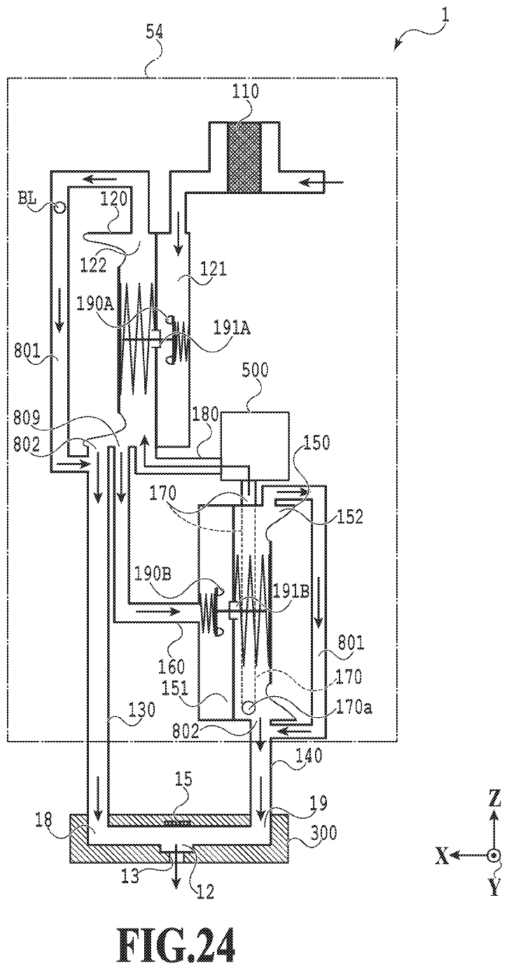

FIG. 24 is a diagram schematically showing the passage configuration in the liquid ejection head 1 according to the present embodiment. The third discharge passage 809, a third outlet 810, and a second slit 811 according to the present embodiment will be described below with reference to FIGS. 23A, 23B, and 24.

As shown in FIG. 24, the first discharge passage 801 and the second discharge passage 802 are also formed in the second pressure adjusting unit 150, as in the first pressure adjusting unit 120. The third discharge passage 809 is provided at the bottom of the first pressure adjusting chamber 122 and communicated with the third outlet 810 and further with the bypass passage 160. Similar to the first slit 808 described above, the second slit 811 is provided extending from the center of the first pressure adjusting chamber 122 to the third outlet 810. The first pressure adjusting chamber 122 and the third discharge passage 809 can secure a certain amount of passage cross section defined by the second slit 811 also in the state where the pressing plate 210 is in contact with the second stopper 805 and the first stopper 806 while the suction process is being performed. Therefore, the flow resistance of the ink passage from the first pressure adjusting chamber 122 through the third discharge passage 809 can be reduced, and the ink flow velocity in the third discharge passage 809 can be ensured at a certain level or higher.

In a case of performing a suction process such as initial filling process for filling ink into a passage, for example, the ink supplied from the liquid ejection apparatus 50 to the first valve chamber 121 is supplied to the first pressure adjusting chamber 122 through the communication port 191A. The ink supplied to the first pressure adjusting chamber 122 is filled inside the first pressure adjusting chamber 122 from vertically below the first pressure adjusting chamber 122 by gravity. This raises the ink level in the first pressure adjusting chamber 122 as the suction process time passes. In this event, the third outlet 810 disposed vertically below the first pressure adjusting chamber 122 becomes submerged below the ink level at an early stage of filling the first pressure adjusting chamber 122. Therefore, the ink is supplied from the third discharge passage 809 to the second pressure adjusting chamber 152 through the bypass passage 160, the second valve chamber 151, and the communication port 191B.

In a case of using choke suction as a method for suction process such as initial filling, the flow velocity of ink discharged from the ejection port by the suction process is determined by the negative pressure of the negative pressure source connected to the cap member. However, this negative pressure value generally shifts to the positive pressure side as time passes from the start of filling. Therefore, the flow velocity of ink discharged from the ejection port decreases over time.

The bubbles BL in the second pressure adjusting chamber 152 are discharged to the collection passage 140 at the ink flow velocity through the first discharge passage 801 with the same mechanism as that described using the first pressure adjusting unit 120. Therefore, the faster the ink flow velocity during discharge, the easier it is to discharge the bubbles BL. By supplying ink into the second pressure adjusting chamber 152 at a relatively early stage after the start of filling, the bubbles BL in the second pressure adjusting chamber 152 are discharged while the ink flow velocity is high, leading to improvement in bubble discharge efficiency.

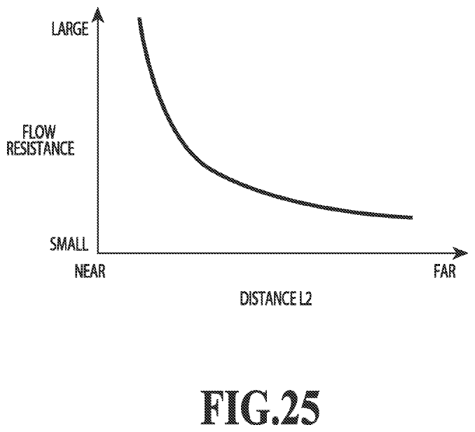

FIG. 25 is a graph showing the relationship between the flow resistance in the passage from the first pressure adjusting chamber 122 to the supply passage 130 through the second discharge passage 802 and the distance L2 between the second outlet 804 and the pressing plate 210 in the displacement direction. As shown in FIG. 25, in the present embodiment, the flow resistance increases non-linearly as the distance L2 between the second outlet 804 and the pressing plate 210 decreases. The flow resistance significantly increases in a state where the pressing plate 210 is in contact with the first stopper 806 at the second outlet 804. This can significantly reduce the ink flow through the second discharge passage 802, making it easier to discharge the bubbles BL by the ink flow through the first discharge passage 801.

The movement of the pressing plate 210 in response to a decrease in the volume of the first pressure adjusting chamber 122 increases the flow resistance of the passage to the supply flow passage 130 through the second discharge passage 802 with respect to the flow resistance of the passage to the supply flow passage 130 through the first discharge passage 801. This makes it possible to provide a liquid ejection head and a liquid ejection apparatus, which can suppress the occurrence of ejection failure.

### Second Embodiment

A second embodiment of the present invention will be described below with reference to the drawings. The basic configuration of the present embodiment is the same as that of the first embodiment, and thus a characteristic configuration will be described below.

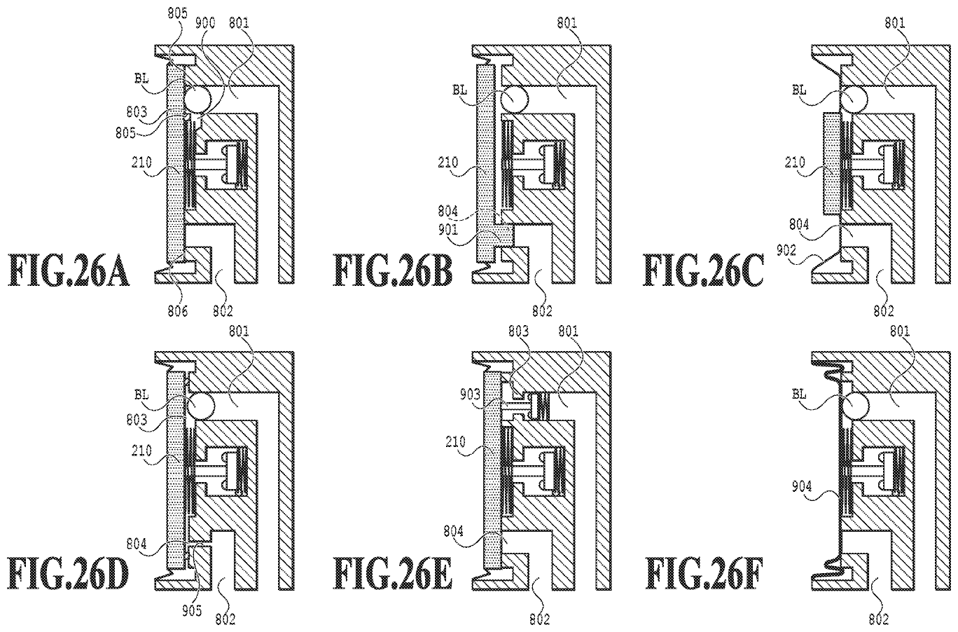

FIG. 26A is a diagram schematically showing a passage configuration in a liquid ejection head 1 according to the present embodiment. In the present embodiment, in a case where the flow of ink from the first valve chamber 121 to the first pressure adjusting chamber 122 becomes faster than the flow velocity during a liquid ejection operation, the pressing plate 210 moves as the volume of the first pressure adjusting chamber 122 decreases. Then, the pressing plate 210 comes into contact with the first stopper 806 and the second stopper 805 substantially at the same timing. The first outlet 803 and the second outlet 804 are thus closed, and no ink is discharged through the first outlet 803 and the second outlet 804. However, in the present embodiment, a bypass discharge passage 900 connecting the first pressure adjusting chamber 122 and the first discharge passage 801 is provided near the first outlet 803. Therefore, even in a state where the first outlet 803 is closed, ink can be discharged from the first pressure adjusting chamber 122 to the first discharge passage 801 through the bypass discharge passage 900. The bubble BL can be easily discharged by the ink flow through the bypass discharge passage 900. If the connection position between the bypass discharge passage 900 and the first discharge passage 801 is on the downstream side of the bubble BL, the bubble BL cannot be discharged. Therefore, it is preferable that the connection position between the bypass discharge passage 900 and the first discharge passage 801 is set as close to the first outlet 803 as possible on the upstream side.

### Third Embodiment

A third embodiment of the present invention will be described below with reference to the drawings. The basic configuration of the present embodiment is the same as that of the first embodiment, and thus a characteristic configuration will be described below.

FIG. 26B is a diagram schematically showing a passage configuration in a liquid ejection head 1 according to the present embodiment. In the present embodiment, the pressing plate 210 is provided with a protrusion 901 at a position corresponding to the second outlet 804. The protrusion 901 is configured to close the second outlet 804 in a case where the pressing plate 210 moves as the volume of the first pressure adjusting chamber 122 decreases. During a liquid ejection operation, the protrusion 901 is separated from the second outlet 804, and thus the liquid is discharged through the second outlet 804. As the suction operation causes the liquid to flow faster from the first valve chamber 121 to the first pressure adjusting chamber 122, the protrusion 901 closes the second outlet 804. With the protrusion 901 blocking the second outlet 804, the flow resistance of the passage to the supply passage 130 through the second discharge passage 802 increases. This can significantly reduce the ink flow through the second discharge passage 802, making it easier to discharge the bubbles BL by the ink flow through the first discharge passage 801.

The shape of the protrusion 901 is not limited to that shown in FIG. 26B. Any shape may be used as long as the flow resistance of the passage to the supply passage 130 through the second discharge passage 802 increases as the pressing plate 210 moves. For example, a conical shape or the like may be employed, whose cross-sectional area gradually decreases in the movement direction of the pressing plate 210, so that the flow resistance is increased by the tip of the protrusion 901 entering the second outlet 804 as the pressing plate 210 moves.

### Fourth Embodiment

A fourth embodiment of the present invention will be described below with reference to the drawings. The basic configuration of the present embodiment is the same as that of the first embodiment, and thus a characteristic configuration will be described below.

FIG. 26C is a diagram schematically showing a passage configuration in a liquid ejection head 1 according to the present embodiment. In the present embodiment, again, as in the above embodiments, the first pressure adjusting chamber 122 is covered with a pressing plate 210 and a flexible member. However, in the present embodiment, the pressing plate 210 covers less area and a flexible member 902 covers more area. In a case where the pressing plate 210 moves as the volume of the first pressure adjusting chamber 122 decreases, the flexible member 902 covers and closes the second outlet 804. With the flexible member 902 blocking the second outlet 804, the flow resistance of the passage to the supply passage 130 through the second discharge passage 802 increases. This can significantly reduce the ink flow through the second discharge passage 802, making it easier to discharge the bubbles BL by the ink flow through the first discharge passage 801.

### Fifth Embodiment

A fifth embodiment of the present invention will be described below with reference to the drawings. The basic configuration of the present embodiment is the same as that of the first embodiment, and thus a characteristic configuration will be described below.

FIG. 26D is a diagram schematically showing a passage configuration in a liquid ejection head 1 according to the present embodiment. The passage configuration of the present embodiment is obtained by setting the diameter of the second outlet 804 smaller than the diameter of the first outlet 803 in the configuration of the first embodiment. Specifically, L1>L2 is established where L1 is the distance between the pressing plate 210 and the first outlet 803 in the displacement direction of the pressing plate 210 and L2 is the distance between the pressing plate 210 and the second outlet 804 in the displacement direction of the pressing plate 210. The diameter of the second outlet 804 is set smaller than the diameter of the first outlet 803.

By setting the diameter of the second outlet 804 smaller than the diameter of the first outlet 803, the ink flow velocity in a passage 905 from the second outlet 804 to the second discharge passage 802 is increased by the movement of the pressing plate 210 as the volume of the first pressure adjusting chamber 122 decreases. As the ink flow velocity increases, the flow resistance in the passage 905 increases with the square of the flow velocity. This can significantly reduce the ink flow through the second discharge passage 802, making it easier to discharge the bubbles BL by the ink flow through the first discharge passage 801.

### Sixth Embodiment

A sixth embodiment of the present invention will be described below with reference to the drawings. The basic configuration of the present embodiment is the same as that of the first embodiment, and thus a characteristic configuration will be described below.

FIG. 26E is a diagram schematically showing a passage configuration in a liquid ejection head 1 according to the present embodiment. In the present embodiment, a valve 903 is provided at a first outlet 803 that connects the first pressure adjusting chamber 122 to the first discharge passage 801. In a case where the pressing plate 210 moves as the volume of the first pressure adjusting chamber 122 decreases, the valve 903 opens to communicate the first pressure adjusting chamber 122 and the first discharge passage 801. In a state where the valve 903 is completely open, the pressing plate 210 is in contact with the second outlet 804, and the second discharge passage 802 is not communicated with the first pressure adjusting chamber 122. This increases the flow resistance of the passage connected to the supply passage 130 through the second discharge passage 802, making it easier to discharge the bubbles BL by the ink flow through the first discharge passage 801.

### Seventh Embodiment

A seventh embodiment of the present invention will be described below with reference to the drawings. The basic configuration of the present embodiment is the same as that of the first embodiment, and thus a characteristic configuration will be described below.

FIG. 26F is a diagram schematically showing a passage configuration in a liquid ejection head 1 according to the present embodiment. In the present embodiment, the pressing plate 210 is not provided, but an elastic thin film 904 is provided instead. As the ink flow velocity increases, the elastic thin film 904 is displaced as the pressure P1 decreases, and the volume of the first pressure adjusting chamber 122 is reduced. The displacement of the elastic thin film 904 causes the second outlet 804 to come into contact with the elastic thin film 904, thus setting the second discharge passage 802 in a non-communication state with the first pressure adjusting chamber 122. In this event, the first outlet 803 connected to the first discharge passage 801 is communicated with the first pressure adjusting chamber 122 without coming into contact with the elastic thin film 904. This can significantly reduce the ink flow through the second discharge passage 802, making it easier to discharge the bubbles BL by the ink flow through the first discharge passage 801.

Note that the above embodiments may be implemented in combination as appropriate. For example, the third embodiment (see FIG. 26B) and the seventh embodiment (see FIG. 26F) may be combined to form the projection 901 on the elastic thin film 904.

### >>Modification>>

Next, various modifications of the above embodiments will be described. The configuration in which ink flows back from the collection passage 140 toward the pressure chamber 12 can be achieved by simply providing the bypass passage 160 and by eliminating a mechanism that functions as a check valve between the pressure chamber 12 and the junction of the bypass passage 160 and the collection passage 140. In the present embodiment, the circulation pump 500 is a pump that sends a liquid in one direction as described above. The junction of the bypass passage 160 only needs to be provided on the upstream side of the circulation pump 500.

### <First Modification>

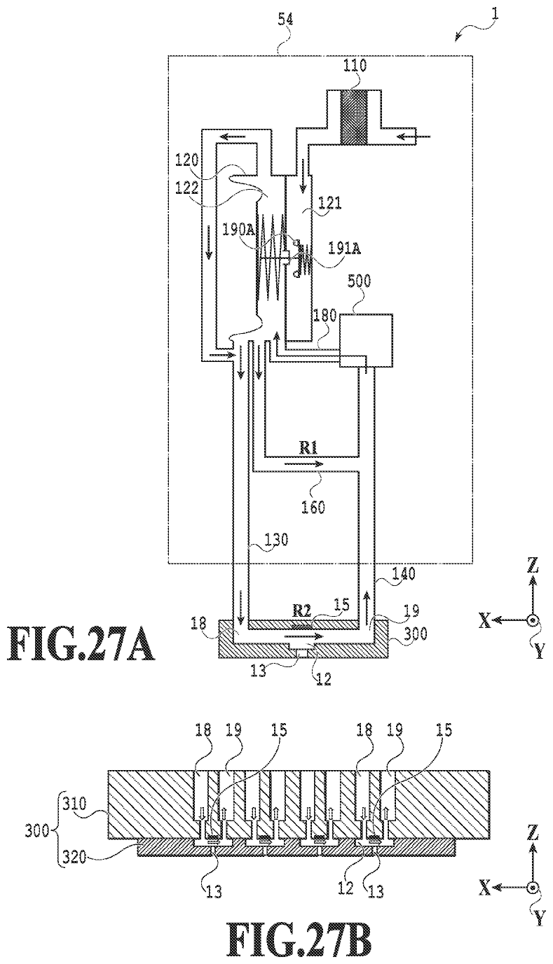

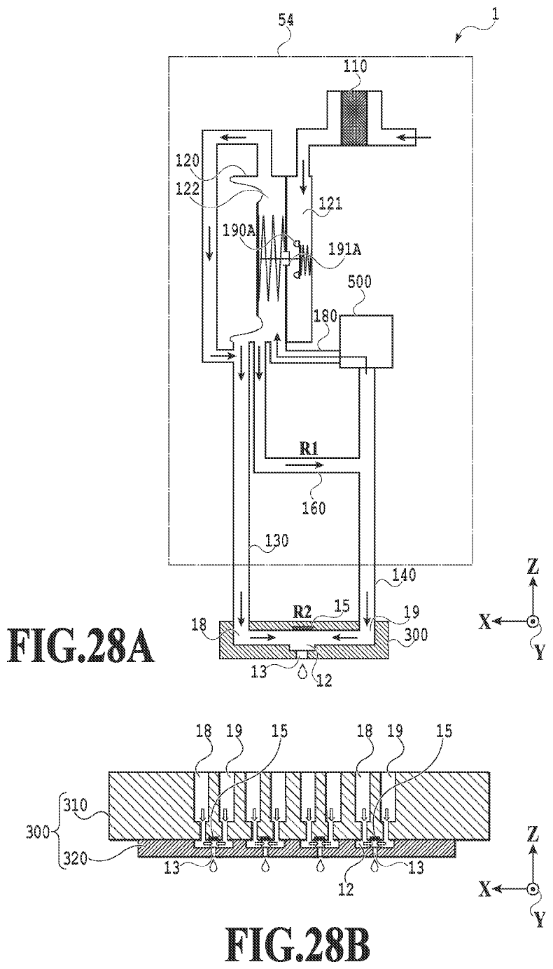

FIGS. 27A and 27B and FIGS. 28A and 28B are diagrams schematically showing circulation paths in a first modification. FIGS. 27A and 27B show a circulation path in a case where circulation is performed without ejection. FIGS. 28A and 28B show a circulation path in a case where high-duty printing is performed. In the first modification, the bypass passage 160 and the collection passage 140 are directly connected without providing the second pressure adjusting unit 150.

In this configuration, R1 is the flow resistance of the passage to the collection passage 140 through the bypass passage 160, and R2 is the flow resistance of the passage from the supply passage 130 to the collection passage 140 through the ejection module 300. Since the amount of ink flowing through each passage is in inverse ratio to the resistance, the ratio of the flow rate of the passage through the bypass passage 160 to the flow rate of the passage through the ejection module 300 is R2 to R1. According to this relationship, each flow resistance is set so that the circulation amount can suppress the thickening of ink near the ejection ports 15 in the ejection module 300. That is, the flow resistance R1 of the bypass passage 160, which sets each flow resistance so that the flow velocity of the liquid in the pressure chamber is equal to or higher than a predetermined value, is controlled by changing the passage cross-section area or the passage length, or by providing a throttle.

In the first modification, again, in a case of performing a print operation at high duty, ink is supplied from both sides into the pressure chamber 12, as shown in FIGS. 28A and 28B. That is, the ink supplied from the first pressure adjusting chamber 122 to the supply passage 130 is supplied to the ejection port 13 through the common supply passage 18 of the ejection module 300. On the other hand, some of the ink supplied from the first pressure adjusting chamber 122 to the bypass passage 160 is supplied to the first pressure adjusting chamber 122 through the circulation pump 500 and the pump outlet passage 180. Some of the ink supplied to the bypass passage 160 is supplied to the collection passage 140 and then to the ejection port 13 through the common collection passage 19 of the ejection module 300. Therefore, the ink ejected from the ejection port 13 is supplied from both the supply passage 130 and the collection passage 140.

### <Second Modification>

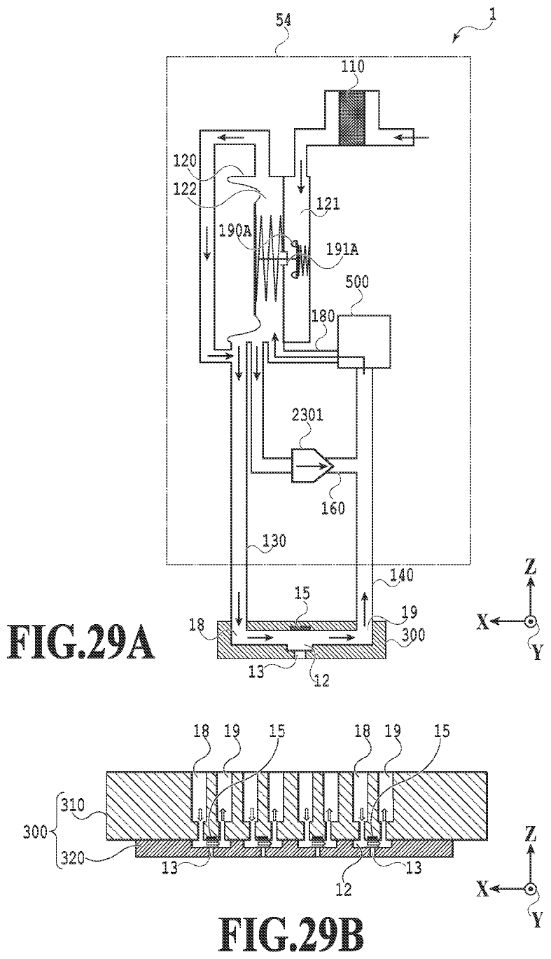

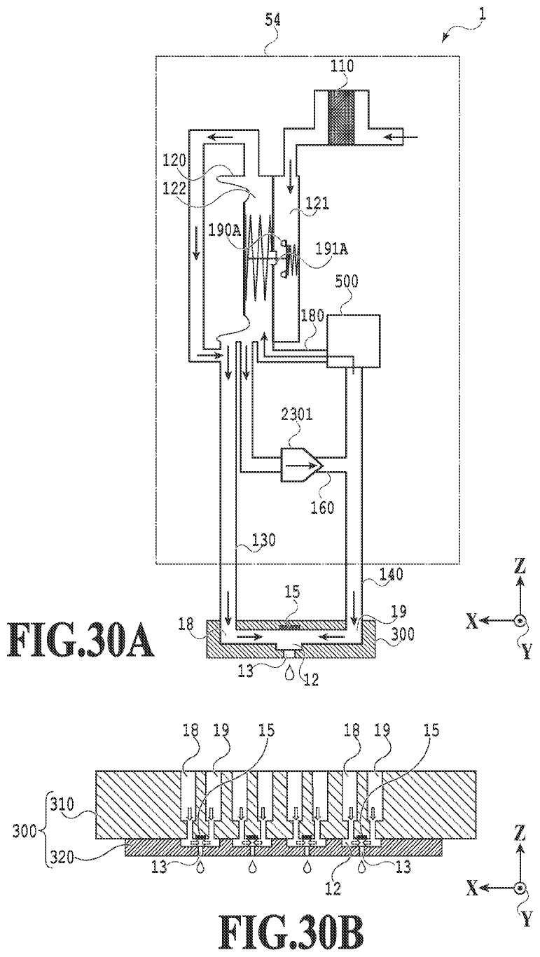

FIGS. 29A and 29B and FIGS. 30A and 30B are diagrams schematically showing circulation paths in a second modification. FIGS. 29A and 29B show a circulation path in a case where circulation is performed without ejection. FIGS. 30A and 30B show a circulation path in a case where high-duty printing is performed. In the second modification, the bypass passage 160 and the collection passage 140 are directly connected without providing the second pressure adjusting unit 150, and a relief valve 2301 is disposed within the bypass passage 160.

The relief valve 2301 is configured such that ink flows from the upstream side to the downstream side of the relief valve when the pressure on the downstream side of the relief valve falls below a certain value. That is, the relief valve is configured to open when the pressure on the collection passage side becomes lower than on the supply passage side by a predetermined value. The flow of ink supply is basically the same as that in the configuration including the second pressure adjusting unit 150, as shown in FIG. 5 and FIGS. 20A and 20B. The circulation amount inside the ejection module 300 is determined by the difference in control pressure between the first pressure adjusting chamber 122 and the relief valve 2301. The control pressure of the relief valve 2301 is set to a circulation amount that can suppress thickening of ink near the ejection ports 15 in the ejection module 300.

In the second modification, again, in a case of performing a print operation at high duty, ink is supplied from both sides into the pressure chamber 12, as shown in FIGS. 30A and 30B. That is, the ink supplied from the first pressure adjusting chamber 122 to the supply passage 130 is supplied to the ejection port 13 through the common supply passage 18 of the ejection module 300. On the other hand, some of the ink supplied from the first pressure adjusting chamber 122 to the bypass passage 160 is supplied to the first pressure adjusting chamber 122 through the circulation pump 500 and the pump outlet passage 180 after passing through the relief valve 2301. Some of the ink supplied to the bypass passage 160 is supplied to the collection passage 140 after passing through the relief valve 2301 and then supplied to the ejection port 13 through the common collection passage 19 of the ejection module 300. Therefore, the ink ejected from the ejection port 13 is supplied from both the supply passage 130 and the collection passage 140.

### <Third Modification>

Next, various modifications of the circulation passage will be collectively described as a third modification. As described above, the configuration in which ink flows back from the collection passage 140 toward the pressure chamber 12 can be achieved by simply providing the bypass passage 160 and by eliminating a mechanism that functions as a check valve between the junction of the bypass passage 160 and the pressure chamber 12. Therefore, if the circulation passage is such that this relationship can be maintained, ink can be supplied to the pressure chamber 12 from both sides, thus improving the ejection stability.

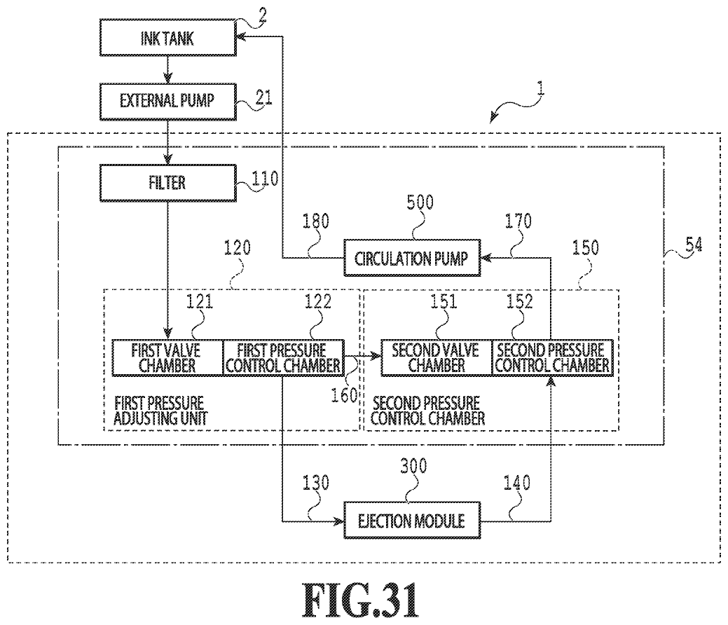

FIG. 31 is a block diagram schematically showing a circulation path. FIG. 31 shows an example where the pump outlet passage 180 located downstream of the circulation pump 500 is connected to the ink tank 2, instead of the first pressure adjusting chamber 122. This configuration can also improve the ejection stability, as in the configurations described above.

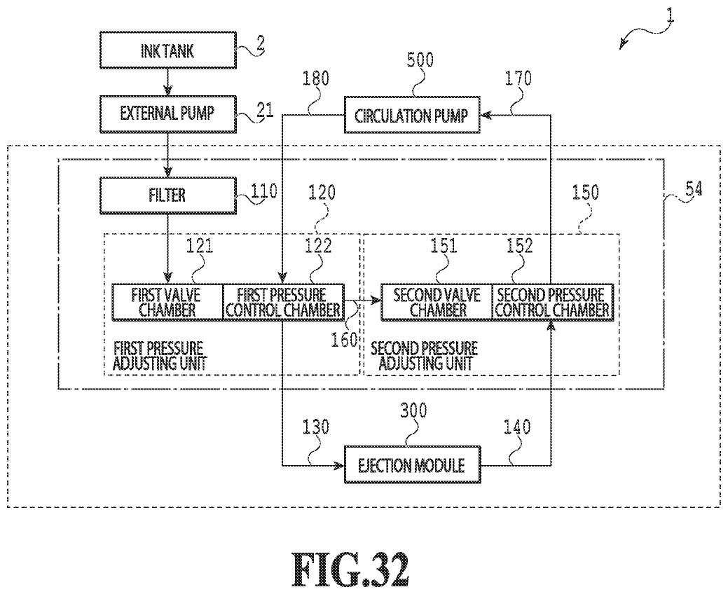

FIG. 32 is a block diagram schematically showing a circulation path. FIG. 32 shows an example where the circulation pump 500 mounted in the liquid ejection head 1 is installed on the main body side of the liquid ejection apparatus 50. The pump inlet passage 170 and the pump outlet passage 180 are also partially disposed outside the liquid ejection head 1. This configuration can also improve the ejection stability, as in the configurations described above.

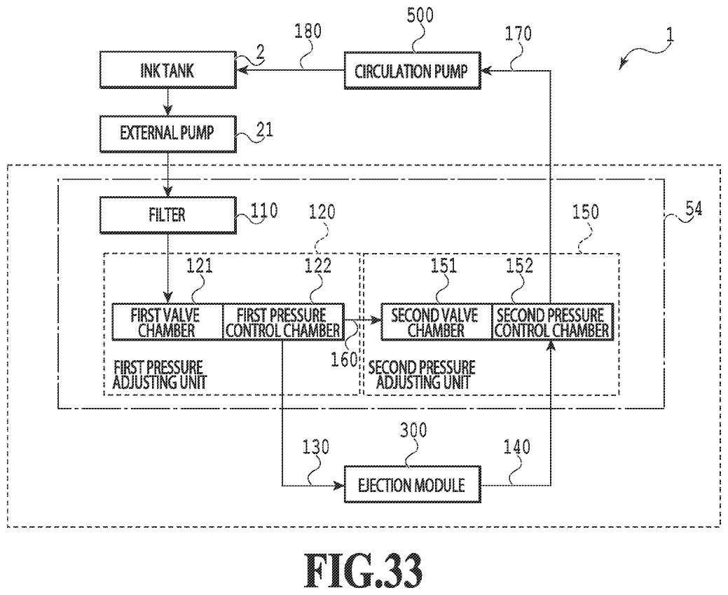

FIG. 33 is a block diagram schematically showing a circulation path. FIG. 33 shows an example where the circulation pump 500 mounted in the liquid ejection head 1 is installed on the main body side of the liquid ejection apparatus 50, and the pump outlet passage 180 is connected to the ink tank 2. This configuration can also improve the ejection stability, as in the configurations described above.

### <Fourth Modification>

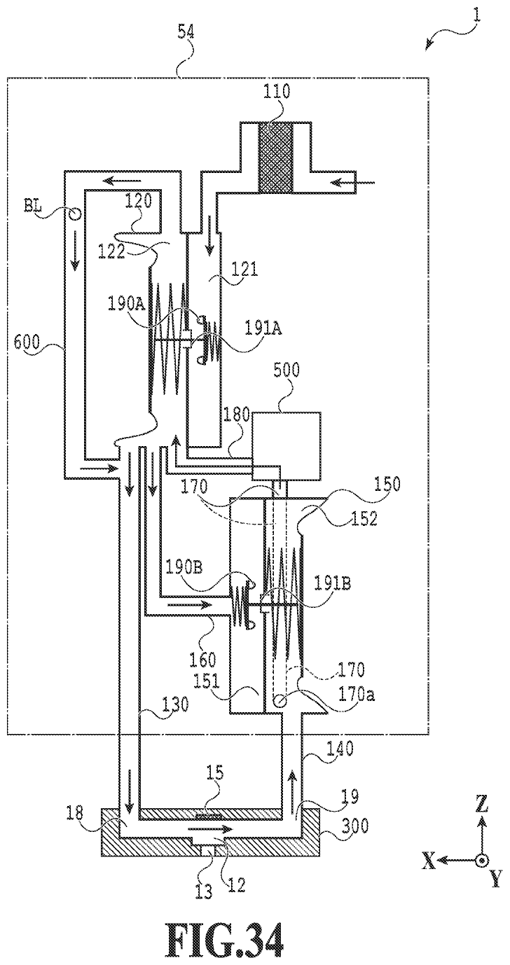

FIG. 34 is a diagram schematically showing a circulation path in a fourth modification. In the fourth modification, the first pressure adjusting unit 120 is provided with a first discharge passage 801 that communicates the first pressure adjusting chamber 122 and the supply passage 130, but the second pressure adjusting unit 150 is not provided with a passage communicating the second pressure adjusting chamber 152 and the collection passage 140. Alternatively, a configuration may also be adopted in which the first pressure adjusting unit 120 is not provided with a passage that communicates the first pressure adjusting chamber 122 with the supply passage 130, and the second pressure adjusting unit 150 is provided with a passage that communicates the second pressure adjusting chamber 152 with the collection passage 140. That is, either one of the first pressure adjusting unit 120 and the second pressure adjusting unit 150 may be provided with a passage that communicates the pressure control chamber with the supply passage (collection passage).

Such a configuration can make it easier for the bubbles BL collected in the upper part of the pressure control chamber to be discharged in at least one of the first pressure adjusting unit 120 and the second pressure adjusting unit 150, thus improving the ejection stability.

### <Fifth Modification>

The liquid ejection head 1 shown in FIG. 1A is a so-called serial type liquid ejection head that ejects ink while moving in the main scanning direction, but the present invention is not limited thereto. The liquid ejection head 1 may also be a so-called full-line liquid ejection head, which has ejection ports formed across the width direction of the printing medium P, and is capable of ejecting across the width direction of the printing medium P without moving in the main scanning direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-067761 filed Apr. 18, 2023, which is hereby incorporated by reference wherein in its entirety.

What is claimed is:

1. A liquid ejection head comprising:
an ejection port for ejecting a liquid;
an ejection element for generating a pressure to eject the liquid from the ejection port;
a pressure chamber provided with the ejection element and communicated with the ejection port; and
a first pressure adjusting unit capable of changing a volume according to the pressure of the liquid and adjusting the pressure of the liquid,
the liquid ejection head further comprising:
a first passage connecting the first pressure adjusting unit and the pressure chamber;
a first outlet provided in a vertically upper part of the first pressure adjusting unit;
a first discharge passage connecting the first outlet and the first passage;
a second outlet provided in the first pressure adjusting unit; and
a second discharge passage connecting the second outlet and the first passage, wherein
in a case where the volume of the first pressure adjusting unit decreases, the liquid ejection head includes a flow resistance increasing unit for increasing a flow resistance in a passage through which the liquid flows from the first pressure adjusting unit to the first passage through the second outlet and the second discharge passage, with respect to a flow resistance in a passage through which the liquid flows from the first pressure adjusting unit to the first passage through the first outlet and the first discharge passage.

2. The liquid ejection head according to claim 1, further comprising:
a pump unit capable of sending the liquid to the first pressure adjusting unit;
a second passage connecting the pump unit and the pressure chamber; and
a bypass passage connecting the first pressure adjusting unit and the second passage.

3. The liquid ejection head according to claim 2, further comprising:
a second pressure adjusting unit provided in the second passage between the pump unit and the pressure chamber, capable of changing its volume according to the pressure of the liquid, and connected to the first pressure adjusting unit through the pump unit to adjust the pressure of the liquid, wherein
the first pressure adjusting unit has a higher control pressure than the second pressure adjusting unit.

4. The liquid ejection head according to claim 3, further comprising:
a third outlet provided in a vertically upper part of the second pressure adjusting unit;
a third discharge passage connecting the third outlet and the second passage;
a fourth outlet provided in the second pressure adjusting unit; and
a fourth discharge passage connecting the fourth outlet and the second passage.

5. The liquid ejection head according to claim 3, wherein
the first pressure adjusting unit includes a first valve chamber, a first pressure adjusting chamber whose volume can be changed, a first opening that communicates the first valve chamber with the first pressure adjusting chamber, a first valve unit configured to open and close the first opening, and a first plate that is displaced as the volume of the first pressure adjusting chamber changes,
the first pressure adjusting chamber includes the first plate that has a part of its surface formed by a first flexible member configured to be displaceable, and is displaceable in conjunction with the first flexible member, and a first biasing member that biases the first plate in a direction of increasing the volume of the first pressure adjusting chamber,
the second pressure adjusting unit includes a second valve chamber, a second pressure adjusting chamber whose volume can be changed, a second opening that communicates the second valve chamber with the second pressure adjusting chamber, a second valve unit configured to open and close the second opening, and a second plate that is displaced as the volume of the second pressure adjusting chamber changes,
the second pressure adjusting chamber includes the second plate that has a part of its surface formed by a second flexible member configured to be displaceable, and is displaceable in conjunction with the second flexible member, and a second biasing member that biases the second plate in a direction of increasing the volume of the second pressure adjusting chamber,
the first valve unit is opened and closed in response to displacement of the first plate and the first flexible member, and
the second valve unit is opened and closed in response to displacement of the second plate and the second flexible member.

6. The liquid ejection head according to claim 5, wherein the bypass passage is connected to the first pressure adjusting chamber in the first pressure adjusting unit.

7. The liquid ejection head according to claim 5, wherein the bypass passage is connected to the second valve chamber in the second pressure adjusting unit.

8. The liquid ejection head according to claim 5, wherein the second pressure adjusting chamber in the second pressure adjusting unit is connected to the pump unit through the second passage.

9. The liquid ejection head according to claim 5, wherein
the flow resistance increasing unit is configured such that a distance between the first plate and the second outlet in a displacement direction of the first plate is shorter than a distance between the first plate and the first outlet in the displacement direction of the first plate.

10. The liquid ejection head according to claim 5, further comprising:
a first stopper formed so as to surround the second outlet,
in a case where the first plate is displaced in a direction of decreasing the volume in the first pressure adjusting chamber, the first plate and at least a part of the first stopper come into contact with each other.

11. The liquid ejection head according to claim 10, further comprising:
one or more second stoppers in the first pressure adjusting chamber, wherein
in a case where the first plate is displaced in a direction of decreasing the volume in the first pressure adjusting chamber, the first plate and at least a part of the first stopper come into contact with each other, and the first plate and at least a part of the second stopper come into contact with each other.

12. The liquid ejection head according to claim 5, further comprising:
a first slit formed in a concave shape in the first pressure adjusting chamber, wherein
one end of the first slit is connected to the first outlet.

13. The liquid ejection head according to claim 6, wherein
the first pressure adjusting unit further includes a third outlet at a connection between the bypass passage and the first pressure adjusting chamber, and
the third outlet is located at least vertically below the first outlet.

14. The liquid ejection head according to claim 13, further comprising:
a second slit formed in a concave shape in the first pressure adjusting chamber, wherein
one end of the second slit is connected to the third outlet.

15. The liquid ejection head according to claim 1, further comprising
a supply passage for supplying the liquid to the first pressure adjusting unit from outside.

16. The liquid ejection head according to claim 5, wherein
the flow resistance increasing unit is a bypass discharge passage provided near the first outlet, and
in a case where the first plate is displaced, the first plate and the first outlet come into contact with each other, and the first plate and the second outlet come into contact with each other.

17. The liquid ejection head according to claim 5, wherein
the flow resistance increasing unit is configured such that a distance between the first plate and the second outlet in a displacement direction of the first plate is shorter than a distance between the first plate and the first outlet in the displacement direction of the first plate,
the first plate includes a protrusion, and
in a case where the first plate is displaced, the protrusion closes the second outlet.

18. The liquid ejection head according to claim 1, wherein
the first pressure adjusting unit includes a valve chamber, a pressure control chamber whose volume can be changed, an opening that communicates the valve chamber with the pressure control chamber, a valve unit configured to open and close the opening, and a flexible member that is displaced as the volume of the pressure control chamber changes,
the flow resistance increasing unit is configured such that a distance between the flexible member and the second outlet in a displacement direction of the flexible member is shorter than a distance between the flexible member and the first outlet in the displacement direction of the flexible member, and
the flexible member closes the second outlet.

19. A liquid ejection head comprising:
an ejection port for ejecting a liquid;
an ejection element for generating a pressure to eject the liquid from the ejection port;
a pressure chamber provided with the ejection element and communicated with the ejection port;
a first pressure adjusting unit capable of changing a volume according to the pressure of the liquid and adjusting the pressure of the liquid; and
a plate that is displaced as the volume of the first pressure adjusting unit changes, the liquid ejection head further comprising:
a first passage connecting the first pressure adjusting unit and the pressure chamber;
a first outlet provided in a vertically upper part of the first pressure adjusting unit;
a first discharge passage connecting the first outlet and the first passage;
a second outlet provided in the first pressure adjusting unit; and
a second discharge passage connecting the second outlet and the first passage, wherein
while the plate is displaced in a direction of decreasing the volume of the first pressure adjusting unit, a distance between the first outlet and the plate in a displacement direction of the plate is longer than a distance between the second outlet and the plate in the displacement direction of the plate.

20. A liquid ejection apparatus capable of mounting a liquid ejection head comprising:
an ejection port for ejecting a liquid,
an ejection element for generating a pressure to eject the liquid from the ejection port,
a pressure chamber provided with the ejection element and communicated with the ejection port, and
a first pressure adjusting unit capable of changing a volume according to the pressure of the liquid and adjusting the pressure of the liquid,
the liquid ejection apparatus further comprising:
a first passage connecting the first pressure adjusting unit and the pressure chamber;
a first outlet provided in a vertically upper part of the first pressure adjusting unit;
a first discharge passage connecting the first outlet and the first passage;
a second outlet provided in the first pressure adjusting unit; and
a second discharge passage connecting the second outlet and the first passage, wherein
in a case where the volume of the first pressure adjusting unit decreases, the liquid ejection apparatus includes a flow resistance increasing unit for increasing a flow resistance in a passage through which the liquid flows from the first pressure adjusting unit to the first passage through the second outlet and the second discharge passage, with respect to a flow resistance in a passage through which the liquid flows from the first pressure adjusting unit to the first passage through the first outlet and the first discharge passage.
